(19) United States
(12) Patent Application Publication
(10) Pub. No.: US 2021/0001308 A1
(43) Pub. Date: Jan. 7, 2021

(54) Method for Producing Silicoaluminophosphate Sorbent

(71) Applicants: Niklas HEDIN, Stockholm (SE); Petr VASILIEV, Solna (SE); Alma JASSO-SALCEDO, Aguascalientes, Ags. (MX); NeoZeo AB, Stockholm (SE)

(72) Inventors: Niklas Hedin, Stockholm (SE); Petr Vasiliev, Solna (SE); Alma Jasso-Salcedo, Aguascalientes, Ags. (MX)

(21) Appl. No.: 16/980,573

(22) PCT Filed: Mar. 13, 2019
(86) PCT No.: PCT/SE2019/050222

§ 371 Date: Sep. 14, 2020

(30) Foreign Application Priority Data
Mar. 14, 2018 (SE) 1830084-8

(51) Int. Cl. B01J 20/30; C01B 37/08; C01B 39/54; B01J 20/18; B01J 20/28; B01D 53/02; C10L 3/10

(52) U.S. Cl. CPC B01J 20/3057; C10L 3/105; C01B 39/54; B01J 20/18; B01J 20/28004; B01J 20/28016; B01D 53/02; C10L 3/104; C01P 2002/72; C01P 2004/03; C01P 2004/20; C01P 2004/42; B01D 2253/106; B01D 2256/245; B01D 2257/504; C10L 2290/542; C01B 37/08

(57) ABSTRACT

The invention relates to a method for synthesizing silicoaluminophosphate sorbents such as SAPO-56 and SAPO-47 comprising the use of a specific structure directing agent (SDA) comprising a mixture of different types of amines The structure providing agent (SDA) comprises N,N,N′,N′-tetramethyl-1,6-hexanediamine (TMHD) and a co-structure providing agent (co-SDA) selected among primary, secondary and tertiary amines comprising up to 15 carbon atoms and mixtures thereof. A preferred SDA comprises isopropylamine, dibutylamine and tripropylamine The sorbents are particularly suitable for up-grading biogas such as separating carbon dioxide from methane.

The present invention relates to a method for synthesizing silicoaluminophosphate sorbents such as SAPO-56 and SAPO-47 sorbents comprising the use of a specific structure directing agent (SDA) comprising a mixture of different types of amines. The sorbents are particularly suitable for separating carbon dioxide from methane.

### BACKGROUND

Biomethane is among the biofuels with the lowest environmental footprint when being produced from suitable waste biomass (X. Liu et al. 2013, 317-323; Hermann et al. 2011, 1159-1171). The fermentation gas (raw biogas) needs to be upgraded by mainly removing CO₂ from the CH₄. Numerous approaches have been commercialized and adsorption-driven techniques are continuing to be explored (Zhou et al. 1414-1441). Many different sorbent powders are studied including microporous and crystalline silicoaluminophosphates (SAPOs) (Bacsik et al. 2016, 613-621).

Silicoaluminophosphates are structurally similar to zeolites but are composed by a framework of Al, P, and Si and O atoms creating a negatively charged framework, which is charged balanced by H⁺ or metal cations (Brent et al. 1984). The smallest pore opening in defining a contiguous pathway is used to classify SAPOs. The corresponding ring size is defined as the number of O-linked Si-, Al-, or P-atoms encircling such a pore opening.

In general, silicoaluminophosphates are synthesized in a hydrothermal method using an organic template which is commonly referred to as a structure directing agent (SDA). The SDA has a profound influence on the average pore diameter of silicoaluminophosphates. Commonly used structure directing agents (SDA) include various types of amines.

The structure directing agent N,N,N′,N′-tetramethyl-1,6-hexanediamine (TMHD) is used for preparing silicoaluminophosphates of type 56 (commonly referred to as SAPO-56). Additional structure directing agents include trimethylamine/1,5-(1,4-diazabicyclo[2.2.2]octane)pentyl dibromide (templates 2/3) (Turrina et al. 2016, 4998-5012) and triethylamine/trimethylamine template 4/2 (D. Wang et al. 2016, 1000-1008).

WO 2017/182995 discloses a method for producing SAPO-56. The method comprises using either 1,4-(1,4-diazabicyclo[2.2.2]octane)butyl cations or 1,5-(1,4-diazabicyclo[2.2.2]octane)pentyl cations in combination with a lower alkyl amine as the structure directing agent. Exemplified lower alkyl amines are trimethylamine or N,N-dimethylethylamine. WO 2017/182995 fails to disclose a structure directing agent comprising N, N, N′, N′-tetramethyl-1,6-hexanediamine and a co-structure providing agent (co-SDA) selected among primary, secondary and tertiary amines comprising up to 15 carbon atoms and mixtures thereof.

US 5370851 relates to crystalline silicoaluminophosphates (SAPOs) and a process for preparing SAPOs. The organic structure directing agent (templating agent) is selected from tripropylamine, dimethylbenzylamine, and tetrapropylammoniumhydroxide. US 5370851 does not disclose the use of N,N,N′,N′-tetramethyl-1,6-hexanediamine (TMHD) in combination with a co-structure providing agent (co-SDA) selected among primary, secondary and tertiary amines comprising up to 15 carbon atoms and mixtures thereof.

There are potential uses of SAPO-56 that involve catalysis and gas separation applications. SAPO-56 is especially suited for upgrading biogas by the capability of the removal of CO₂ from a mixture of methane and CO₂ with a high selectivity. However, SAPO-56 is expensive due to the use of N,N,N′,N′-tetramethyl-1,6-hexanediamine. In the present invention N,N,N′,N′-tetramethyl-1,6-hexanediamine has been partly replaced a primary, secondary and tertiary amines. The experimental data shows that a significant part of N,N,N′,N′-tetramethyl-1,6-hexanediamine can be replaced by primary, secondary and tertiary amines without compromising the characteristics of the SAPO-56. Typically, seeds are used when using co-templates in the synthesis of SAPO-56.

### DETAILED DESCRIPTION OF THE INVENTION

The present invention relates to a method for synthesizing a silicoaluminophosphate sorbent comprising: providing a reaction mixture, said reaction mixture comprising: a silicon-containing composition, an aluminum-containing composition, a phosphorous-containing composition, and a structure providing agent (SDA); crystallization of the reaction mixture thereby providing crystallized silicoaluminophosphate; recovering crystalline silicoaluminophosphate from the mixture; wherein the structure providing agent (SDA) comprises N,N,N′,N′-tetramethyl-1,6-hexanediamine (TMHD) and a co-structure providing agent (co-SDA) selected among primary, secondary and tertiary amines comprising up to 15 carbon atoms and mixtures thereof.

According to an embodiment the silicoaluminophosphate sorbent is selected among SAPO-56 and SAPO-47.

According to a further embodiment the silicoaluminophosphate sorbent is SAPO-56.

As presented the structure providing agent (SDA) comprises N,N,N′,N′-tetramethyl-1,6-hexanediamine (TMHD) and a co-structure providing agent (co-SDA) selected among primary, secondary and tertiary amines comprising up to 15 carbon atoms and mixtures thereof. N,N,N′,N′-tetramethyl-1,6-hexanediamine (TMHD) and the primary, secondary and tertiary amines comprising up to 15 carbon atoms and mixtures thereof may also collectively be referred to as SDA:s.

The term ‘selected among’ may also be replaced by any one of the terms ‘chosen among’, ‘selected from the group comprising’ or ‘selected from the group consisting of’.

The co-SDA may be selected among primary amines comprising up to 6 carbon atoms, secondary amines comprising up to 10 carbon atoms and tertiary amines comprising up to 12 carbon atoms.

The primary amines are preferably characterized of comprising up to 4 carbon atoms, or up to 3 carbon atoms. A preferred primary amine is propylamine and particularly isopropylamine (IPA).

The secondary amines typically comprise two alkylgroups of from 2 to 5 carbon atoms each. The alkyl groups may be branched. Preferably, the two alkylgroups have an equal amount of carbon atoms and are non-branched. Dibutylamine (DBA) is an exemplified secondary amine.

Tertiary amines preferably have alkylgroups. All three alkylgroups may have an equal amount of carbon atoms, typically from 2 to 5 carbon atoms. An example of a suitable tertiary amine is tripropylamine (TPA).

According to an embodiment, the co-SDA may be selected among primary amines comprising an alkylgroup of up to 4 carbon atoms, secondary amines comprising two alkyl groups of up to 5 carbon atoms each and tertiary amines comprising three alkylgroups comprising up to 4 carbon atoms each.

The co-SDA may constitute of only primary amines, only secondary amines or only tertiary amines. Also, the co-SDA may comprise any mixture of primary, secondary and tertiary amines, such as a mixture of primary and secondary, or mixture of primary and tertiary amines, or mixtures secondary and tertiary amines, or a mixture of primary, secondary and tertiary amines.

According to an embodiment the co-SDA is selected among isopropylamine (IPA), dibutylamine (DBA), tripropylamine (TBA) and mixtures thereof.

According to an embodiment the SDA comprises a primary amine comprising a saturated hydrocarbon comprising up to 4 carbon atoms.

According to a further embodiment the SDA comprises a primary amine comprising a saturated hydrocarbon comprising up to 3 carbon atoms.

According to yet a further embodiment the saturated hydrocarbon of any of the primary amines of any embodiment is branched.

According to yet a further embodiment the saturated hydrocarbon of the primary amine of any one of the embodiments is configured such that two methyl groups are attached to the same carbon atom.

A further embodiment relates to the method preparing a silicoaluminophosphate 56 sorbent comprising: providing a reaction mixture, said mixture comprising: a silicon-containing composition, an aluminum-containing composition, a phosphorous-containing composition, and a structure providing agent (SDA); crystallization of the reaction mixture thereby providing crystallized silicoaluminophosphate 56; recovering crystalline silicoaluminophosphate 56 from the mixture; wherein the structure providing agent (SDA) comprises N,N,N′,N′-tetramethyl-1 ,6-hexanediamine (TMHD) and a co-structure providing agent (co-SDA) selected among primary amines comprising a saturated hydrocarbon comprising up to 6 carbon atoms. Preferably, the primary amine is isopropylamine (IPA).

The SDA may contain other compounds that those specified herein. However, according to an embodiment the SDA consist essentially of N,N,N′,N′-tetramethyl-1 ,6-hexanediamine and any one of the co-SDA:s specified herein. Preferably, at least about 90 weight % of the SDA, suitably at least 95 weight %, preferably at least 99 weight % constitutes of TMHD and any of the co-SDA:s specified herein.

A characteristic of the present invention is the discovery that a significant part of the TMHD can replaced with more economically viable primary, secondary and tertiary amines and still obtain SAPO-56.

The term “about” means approximately and refers to a range that is optionally +25%, preferably +10%, more preferably, +5%, or most preferably +1% of the value with which the term is associated.

The SDA suitably comprises TMHD and the co-SDA in a molar ratio of up to about 1:4, preferably up to about 1:3.5, more preferably up to about 1:3.0, more specifically up to about 1:2.3.

The molar ratio of TMHD to primary amines comprising a saturated hydrocarbon comprising up to 6 carbon atoms, such as IPA, is preferably of up to about 1:4, preferably up to about 1:3.5, more preferably up to about 1:3.0, more specifically up to about 1:2.3.

According to yet a further embodiment the molar ratio of TMHD to co-SDA, i.e. primary, secondary and tertiary amine as specified herein, is not more than about 90 mol %, not more than about 80 mol %, not more than about 70 mol %, not more than about 60 mol %, not more than about, 50 mol %, not more than about 40 mol %, not more than about 30 mol %, not more than about 25 mol %, all values based on total moles of components of the SDA.

A number of silicon compounds and their mixtures can be used as the silicon component for use in the silicon-containing composition. The silicon compounds include, but are not limited to silica sol silica gel, colloidal silica, fumed silica, silicic acid, tetraethyl silicate, tetramethyl silicate, and mixtures thereof. A preferred silicon component comprises a material selected from the group consisting of silica sol, silica gel, colloidal silica, fumed silica, silicic acid, and mixtures thereof.

Many aluminum compounds and their mixtures are suitable for use as the aluminum component of the aluminum-containing composition. The aluminum compounds include, but are not necessarily limited to aluminum oxide, boehmite, pseudo boehmite, aluminum hydroxy chloride, aluminum alkoxides such as aluminum tri-isopropoxide, aluminum tri-ethoxide, aluminum tri-n-butoxide and aluminum tri-isobutoxide, and mixtures thereof. A preferred aluminum component comprises a material selected from the group consisting of aluminum hydroxide, boehmite and pseudo boehmite.

The phosphorus compounds suitable for use as the phosphorus component of the phosphorous-containing composition include but are not limited to orthophosphoric acid, phosphorus acid, trimethyl phosphate, triethyl phosphate, and mixtures thereof. A preferred phosphorus component comprises orthophosphoric acid (H₃PO₄). Another preferred phosphorus component comprises the commercially available 85 wt % phosphoric acid (in water). Alternately, phosphorus oxides (P₂O₃, P₂O₄, P₂O₅ and POCl₃) can be used, preferably after they are dissolved in a suitable solvent such as water.

The crystallization is suitably conducted under autogenous conditions at temperatures from about 150 to about 300° C., from about 180 up to about 250° C., and from about 190 up to about 230° C. The crystallization can be maintained from hours up to several days. The duration of crystallization may be form about 5 up to about 200 hours, from about 20 up to about 150 hours, from about 50 up to about 130 hours. The crystallization may be performed in an autoclave.

According to an embodiment crystallization of SAPO-56 is conducted at a temperature between about 190° C. up to about 230° C., between about 200° C. up to about 220° C., for up to about 60 hours, up to about 55 hours.

The crystalline silicoaluminophosphate may be recovered by any suitable techniques. Filtration or centrifugation or a combination of both is may be implemented.

The method for preparing the silicoaluminophosphate sorbent may also include a step where inter alia organic material such as any SDA, is removed from the recovered crystalline silicoaluminophosphate. The removal of organic material from the silicoaluminophosphate is usually performed at temperatures facilitating the decomposition and/or oxidation of the organic materials. The removal of organic material from crystalline silicoaluminophosphate is often referred to as calcination. Calcination may also remove metal salts and furthermore promotes the exchange of metal ions within the within the microporous crystalline sorbent. The decomposition and/or oxidation of the silicoaluminophosphate is typically conducted at temperatures above about 400° C. up to about 1200° C. The duration of calcination may vary considerably from minutes up to several hours or even days. Typically, the duration of the calcination where organic material is decomposed and/or oxidized is from about 4 up to about 24 hours. Calcination is performed in air, or under an oxygen atmosphere.

Other gases may be present such as nitrogen, and helium. Under certain circumstances the presence of water vapor may be advantageously under calcination.

The calcination may be performed within a temperature range from about 400° C. up to about 1200° C. for a duration from about 2 up to 24 hours.

The temperatures used in calcination depend upon the components in the material to be calcined and generally are between about 400° C. to about 900° C. for approximately 1 to 8 hours. In some cases, calcination can be performed up to a temperature of about 1200° C. In applications involving the processes described herein calcinations are generally performed at temperatures from about 400° C. to about 700° C. for approximately 1 to 8 hours, preferably at temperatures from about 550° C. to about 650° C. for approximately 1 to 4 hours. The calcination may be performed at a temperature from about 550° C. and for about 4 up to 24 hours, e.g. from about 6 up to about 16 hours.

Prior to calcination the recovered crystalline silicoaluminophosphate may be further purified. Purification may be accomplished by washing with deionized water, suitably several times.

According to an embodiment the reaction mixture may comprise seeds for facilitating the crystallization. The seeds are suitably crystalline silicoaluminophosphates of the same type which are intended to be prepared.

SAPO-56 has a topological type referred to as AFX as recognized by the International Zeolite Association (IZA) Structure Commission. SAPO-56 is crystalline, or at least comprises crystalline phases. Depending on use the SAPO-56 may be referred to as sorbent, adsorbent, catalyst or molecular sieve to mention a few. Other crystalline phases may also be present, but the primary crystalline phase is SAPO-56. Suitably, at least about 90 weight percent is SAPO-56 (AFX), preferably at least about 95 weight percent SAPO-56 (AFX), and even more preferably at least about 97 or at least about 99 weight percent SAPO-56 (AFX). Preferably, the SAPO-56 is substantially free of other crystalline phases and is not an intergrowth of two or more framework types. By “substantially free” with respect to other crystalline phases, it is meant that the molecular sieve contains at least 90, more suitably 95, and typically 99 weight percent of SAPO-56 (AFX).

The SAPO-56 produced by using an SDA as presented herein may exhibit a characteristic X-ray diffraction pattern as shown in table 1.

TABLE 1

| 2θ | D(Å) | Relative Intensity |
|---|---|---|
| 7.27 | 12.16 | m |
| 8.49 | 10.41 | vs |
| 11.41 | 7.76 | s |
| 12.73 | 6.95 | m |
| 14.75 | 6.01 | w |
| 15.11 | 5.86 | w |
| 15.42 | 5.75 | m |
| 17.21 | 5.15 | m |
| 17.59 | 5.04 | s |
| 20.09 | 4.42 | s |
| 21.53 | 4.13 | s |
| 21.86 | 4.07 | m |
| 23.34 | 3.81 | M |
| 25.81 | 3.45 | m |
| 27.67 | 3.22 | m-s |
| 28.36 | 3.15 | w |
| 29.83 | 3.00 | m |
| 30.26 | 2.95 | m |
| 30.64 | 2.92 | w |
| 31.27 | 2.86 | m |
| 31.49 | 2.84 | w |
| 32.10 | 2.79 | w |
| 33.34 | 2.69 | m |
| 34.43 | 2.60 | w |
| 42.64 | 2.12 | w |
| 43.34 | 2.09 | w |
| 45.91 | 1.98 | w |
| 46.79 | 1.94 | w |
| 47.63 | 1.91 | w |
| 49.77 | 1.83 | w |
| 50.56 | 1.81 | w |
| 50.68 | 1.80 | w |
| 53.20 | 1.72 | w |
| 53.35 | 1.72 | w |

The SAPO-56 may be represented by the empirical formula:

mR:(SiₓAl_{y}P_{z})O₂

were R represents at least one organic structure directing agent (SDA) comprising isopropylamine (IPA) present in the intra-crystalline pore system; m is the molar amount of R per mole of (SiₓAl_{y}P_{z})O₂ and has a value of from zero to about 0.3; x is the mole fraction of silicon an varies from about 0.01 to about 0.98; y is the mole fraction of aluminium and varies from about 0.01 to about 0.60; z is the mole fraction of phosphorus and varies from about 0.01 to about 0.52; where x+y+z=1.

The SAPO-56 may be characterized by the empirical formula and exhibit a characteristic X-ray diffraction pattern as shown in table 1.

A further aspect of the invention relates to silicoaluminophosphate sorbents obtainable by any of the methods set forth herein.

A still further aspect relates to a silicoaluminophosphate sorbent comprising a structure providing agent (SDA) comprising N,N,N′,N′-tetramethyl-1,6-hexanediamine (TMHD) and a co-structure providing agent (co-SDA) selected among primary, secondary and tertiary amines comprising up to 15 carbon atoms and mixtures thereof. The silicoaluminophosphate sorbent may be any of the types specified herein, specifically SAPO-56. The structure providing agent (SDA) comprised in the silicoaluminophosphate sorbents may be any SDA disclosed herein, such as co-SDA:s comprising IPA, DBA, or TPA or a mixture of all three.

Yet a still further aspect relates to SAPO-56 comprising a SDA comprising TMHD and co-SDA:s, where the amount of co-SDA:s is at least about 10 mol %, at least about 15 mol % at least about 20 mol % based on total amount of SDA and co-SDA and where the BET specific surface area (m²/g) is above about 500, above about 550.

A still further aspect relates to SAPO-56 comprising particles said particles having a mean particle size of less than about 1000 nm, less than about 600 nm, less than about 500 nm. The particles (crystals) are the particles obtained after crystallization and after optional recovery and washing and optional calcination. The shape of the particles (crystals) are preferably bipyramidal and/or hexagonal plates.

A still further aspect relates to SAPO-56 having particles being bipyramidal and/or hexagonal plates.

A further aspect of the invention is the use of a silicoaluminophosphate sorbent, such as SAPO-56, obtained by any of the methods disclosed herein in a process for up-grading of biogas.

The silicoaluminophosphate sorbent, such as SAPO-56, obtained by any of the methods disclosed herein may also be implemented in a process for removal of CO₂ from a mixture comprising methane.

### FIGURES

FIG. 1: XRD patterns of the as synthesized products obtained with different ratios of TMHD to IPA and the reference pattern of SAPO-56 (indicated as SAPO-56 00-052-1178). Entries from top to bottom: SAPO-56-00-052-1178, S4 100% TMHD, S12 60% TMHD:40% IPA, S15 50% TMHD:50% IPA, S20 40% TMHD:60% IPA, S38 70% TMHD:30% IPA, S56 80% TMHD:20% IPA, S58 10% TMHD:90% IPA.

FIG. 2: X-ray diffraction patterns of the as synthesized products obtained with co-SDA 70% IPA: 30% TMHD as function of the crystallization time at 210° C. (Entries top to bottom: SAPO-56 00-052-1178, 39A (48 h), 39B (77 h), 39C (98 h), S31A (114 h).

FIG. 3: X-ray diffraction patterns of the as synthesized products obtained with co-SDA 70% IPA:30% TMHD and 48 h crystallization time as function of the temperature. Entries top to bottom: SAPO-56 00-052-1178, S45 180° C., S47 190° C., S50 200° C., S49 210° C.

FIG. 4: XRD patterns of the as synthesized and calcined SAPO-56 obtained with co-SDA SDA 70% IPA:30% TMHD and 48 h (Sample S50 of Table 4) showing the structure stability after co-SDAs removal. The reference pattern of SAPO-56 00-052-1178 is add for comparison. Entries top to bottom: SAPO-56 00-052-1178, S50, S50 650° C.

FIG. 5: CO₂ (top line) and CH₄ (bottom line) adsorption isotherms measured at 10° C. for SAPO-56 30% TMHD: 70% IPA (sample S50 of Table 4).

FIG. 6: XRD patterns of the as synthesized products obtained with co-SDA 60% TMHD: 40% IPA in contrast with the reference pattern of SAPO-56 00-052-1178. Entries top to bottom: SAPO-56 00-052-1178, S10, S11, S12, S16.

FIG. 7: SEM images of SAPO-56 using 60% TMHD: 40% IPA (sample S12 of Table 4) shows at least two different morphologies: short hexagonal pillar and based faced pyramids.

FIG. 8: XRD patterns of the as synthesized products obtained with co-SDA 50% TMHD: 50% IPA in contrast with the reference pattern of SAPO-56 00-052-1178. Entries top to bottom: SAPO-56 00-052-1178, S5, S13, S14, S15, S17, S22.

FIG. 9: SEM images of SAPO-56 as-synthesized using 50% TMHD: 50% IPA (sample S17 of Table 4) show base faced pyramids of approximately 2 μm size.

FIG. 10: XRD patterns of the as synthesized products obtained with co-SDA 40% TMHD: 60% IPA in contrast with the reference pattern of SAPO-56 00-052-1178. Entries top to bottom: SAPO-56 00-052-1178, S18, S19, S20, S21, S27.

FIG. 11: SEM images of SAPO-56 using 40% TMHD: 60% IPA (sample S12 of Table 4)

FIG. 12: XRD patterns of the as synthesized products obtained with co-SDA 30% TMHD: 70% IPA in contrast with the reference pattern of SAPO-56 00-052-1178 using different autoclave filling. Entries top to bottom: SAPO-56 00-052-1178, S4, S48 20% v/v, S49 30% v/v, S50 40% v/v.

FIG. 13: SEM images of SAPO-56 using 30% TMHD: 70% IPA (sample S50 of Table 4)

FIG. 14: SEM images of (a, b) SAPO-47 and (c) SAPO-56/SAPO-47 intergrowth obtained using 30% TMHD: 70% IPA and 48 h at different crystallization temperatures. Reaction conditions of sample S45, S47 and S50 of Table 4.

FIG. 15: XRD patterns of the as synthesized products obtained with co-SDA 20% TMHD: 80% IPA. The characteristic peaks at low angle 2θ values of 9.48 and 12.9 correspond to SAPO-47 (Treacy and Higgins 2007) which is synthesized using n-propylamine as template (Xu et al. 2015, 123-128). Entries top to bottom: SAPO-56 00-052-1178, S55, S56.

FIG. 16: SEM images of SAPO-47 synthesized using 20% TMHD: 80% IPA (sample S55 of Table 4) showing hexagonal plates of rough surface.

FIG. 17: XRD patterns of the as synthesized products obtained with co-SDA 10% TMHD: 90% IPA. The characteristic peaks at low angle 2θ values of 9.48 and 12.9 correspond to SAPO-47 (Treacy and Higgins 2007) which is synthesized using n-propylamine as template (Xu et al. 2015, 123-128). Entries top to bottom: SAPO-56 00-052-1178, S57, S58.

FIG. 18: SEM images of SAPO-47 synthesized using 10% TMHD: 90% IPA (sample S58 of Table 4) showing semi-circular grains composed by nanosized cubes.

FIG. 19: N₂ adsorption isotherms measured at −196° C. for sample S50 70% IPA: 30% TMHD (BET SSA 670 m²/g).

FIG. 20: CO₂ (top line) and CH₄ (bottom line) adsorption isotherms measured at 0° C. for SAPO-56 obtained using TMHD and 95 h (sample S5 Table 1).

FIG. 21: CO₂ (top line) and CH₄ (bottom line) adsorption isotherms measured at 0° C. for SAPO-47 using 80% IPA: 20% TMHD and 51 h (sample S56 of Table 4).

FIG. 22: CO₂ (top black solid lines) and CH₄ (bottom red dotted lines) adsorption isotherms measured at 0° C. for SAPO-56 synthesized using (A) only TMHD and (B) TMHD:co-SDAs. See Table 5 for detailed information.

FIG. 23: (A) Synthesis composition diagram of the gel used for the synthesis of SAPO-56 using TMHD. (B) XRD pattern of SAPO-56 as-synthesized samples. Literature data on the synthesis of pure SAPO-56 (small blue circles) are presented in 1A. The SiO₂ in the ternary diagram is defined as SiO₂/(SiO₂+Al₂O₃+P₂O₅)_{gel}. (Consult the color version of this Figure).

FIG. 24: (A) Synthesis composition diagram of gels, (B) XRD pattern, (C-D) SEM images of samples synthesized using IPA as co-SDA. Gel compositions used for the synthesis of pure SAPO-56 and SAPO-47 reported in the literature are highlighted in (A) in addition to the points of this study. Table 5 for detailed gel composition and reaction conditions. The SiO₂ in the ternary diagram is defined as SiO₂/(SiO₂+Al₂O₃+P₂O₅)_{gel}. TMHD and IPA stands for N,N,N′,N′-tetramethyl-1,6-hexanediamine and isopropylamine, respectively. Consult the color version of this figure.

FIG. 25: (A) Synthesis composition diagram of gels, (B) XRD pattern, (C-D) SEM images of samples synthesized using DBA as co-SDA. Gel compositions used for the synthesis of pure SAPO-56 and SAPO-17 reported in the literature are highlighted in (A) in addition to the points of this study. Table 5 for detailed gel composition and reaction conditions. The SiO₂ in the ternary diagram is defined as SiO₂/(SiO₂+Al₂O₃+P₂O₅)_{gel}. TMHD and DBA mean N,N,N′,N′-tetramethyl-1,6-hexanediamine and DBA. Consult the color version of this figure.

FIG. 26: A) Synthesis composition diagram of gels, (B) XRD pattern, (C-D) SEM images of samples synthesized using TPA as co-SDA. Gel compositions used for the synthesis of pure SAPO-56, SAPO-17 and SAPO-11 reported in the literature are highlighted in (A) in addition to the points of this study. Table 5 presents the detailed gel compositions and reaction conditions. The SiO₂ in the ternary diagram is defined as SiO₂/(SiO₂+Al₂O₃+P₂O₅)_{gel}. TMHD and TPA mean N,N,N′,N′-tetramethyl-1,6-hexanediamine and tripropylamine. Consult the color version of this figure.

### EXPERIMENTAL DATA

SAPO-56 seeds were synthesized by a hydrothermal method using 100% of the classical and expensive structure directing agent, template 1, N,N,N′,N′ tetramethyl-1,6-hexanediamine (99% Sigma Aldrich) following the protocol reported (Xie et al. 2013, 6732-6735). Precursors were added in the following order: H₂O, phosphoric acid, aluminum source, silica source, and the SDA. A starting solution of phosphoric acid (85 wt %, Sigma Aldrich) in distilled water (DI H₂O) and the aluminum source, pseudoboehmite, (Aluminum Corporation of China, Shandong) was prepared under vigorously stirring for two hours at room temperature. The silica source was added to the former solution in the form of LUDOX® HS-40 colloidal silica, 40 wt. % suspension in water (Sigma Aldrich) and stirred continuously for 1 h. Finally, the SDA was added. A temporary increase in the temperature and concurrent thickening of the mixture was visible during the first minutes of the mixing. The mixture was continued to be stirred for at least 18 h at room temperature in closed vessel. The prepared suspension/gel having a pH of 10 was transferred to Teflon-lined stainless-steel autoclaves and introduced in a pre-heated oven at a temperature of 210° C. The crystallization of SAPO-56 was performed hydrothermally under an autogenous pressure for 96 h. The formed product had two layers. The minor top layer of a yellow and gelatinous appearance was discarded. The white cake at bottom of the autoclaves was recovered, washed with an excess of deionized (DI) H₂O (using at least three centrifugations, with 6000 rpm for 5 min, and washing cycles) and dried at a temperature of 80° C. overnight. Finally, as-synthesized SAPO-56 was “calcined” at a temperature of 650° C. for 16 h before further testing was performed.

SAPO-56 was prepared using N,N,N′,N′ tetramethyl-1,6-hexanediamine (TMHD: 99% Sigma Aldrich) and IPA (>99.5%, Sigma Aldrich) as a co-structure directing agent.

The precursors were added in the following order: water, phosphoric acid, aluminum source, silica source, TMHD, IPA, and seeds. The ratio of IPA: TMHD was varied using IPA from 10 to 90% in molar percentage.

A starting solution of phosphoric acid (85 wt %, Sigma Aldrich) in distilled water (DI H₂O) and the aluminum source, pseudoboehmite, (Aluminum Corporation of China, Shandong) was prepared under vigorously stirring for two hours at room temperature. The silica source was added to the former solution in the form of LUDOX® HS-40 colloidal silica, 40 wt. % suspension in water (Sigma Aldrich) and stirred continuously for 1 h. Finally, the TMHD and IPA was added in a sequence where TMHD was added first and then after 5 minutes followed by the addition of IPA.

A temporary increase in the temperature and a thickening of the mixture was visible during the first minutes after TMHD addition; however, the viscosity of the mixtures returned, roughly, back to its initial value after the addition of the IPA. The suspension/gel was continuously stirred for at least 18 h at room temperature in closed vessel. The solution with a pH=7 was transfer to Teflon® lined stainless-steel autoclaves and placed in a pre-heated oven at a temperature of 195-210° C. under autogenous pressure. A crystallization time of 48 h was applied. The gelatinous top layer of the formed product was discarded, and the white cakes at the bottom of the autoclaves were recovered. The recovered white cakes were subsequently washed with an excess of DI H₂O (and at least three centrifugations, at 6000 rpm for 5 min, and washing cycles were applied) and dried at a temperature of 80° C. overnight. Finally, the as-synthesized product was “calcined” at a temperature of 650° C. for 12 h before further experimentation.

Table 2 summarizes the different mixture compositions tested for the synthesis SAPO-56 using only TMHD and different rations of TMHD and IPA. For more detail, Table 2 shows some compositions using co-SDAs.

TABLE 2

| | | | | | | | | | | | Working | |
|---|---|---|---|---|---|---|---|---|---|---|---|---|
| | | | | | | | | | Temperature | Time | volume | Crystalline |
| Sample | TMHD:IPA | Al₂O₃ | P₂O₅ | SiO₂ | TMHD | IPA | H₂O | Seed | (° C.) | (h) | (v/v %) | phase |
| S5 | 100%:0% | 0.9 | 1.0 | 1.9 | 2.2 | 0 | 54.9 | NO | 210 | 95 | 16% | SAPO-56 |
| S12 | 60%:40% | 0.8 | 1.0 | 0.9 | 1.3 | 0.9 | 52.3 | YES | 210 | 95 | 14% | SAPO-56 |
| S15 | 50%:50% | 0.8 | 1.0 | 0.9 | 1.0 | 1.1 | 52.3 | NO | 210 | 95 | 14% | SAPO-56 |
| S20 | 40%:60% | 0.8 | 1.0 | 0.9 | 0.8 | 1.3 | 52.2 | YES | 210 | 96 | 14% | SAPO-56 |
| S38 | 30%:70% | 0.7 | 1.0 | 0.7 | 0.5 | 1.2 | 42.7 | YES | 210 | 48 | 14% | SAPO-56 |
| S55 | 20%:80% | 0.7 | 1.0 | 0.8 | 0.4 | 1.4 | 44.0 | YES | 195 | 51 | 40% | SAPO-47 |
| S58 | 10%:90% | 0.7 | 1.0 | 0.8 | 0.2 | 1.6 | 44.3 | YES | 195 | 51 | 40% | SAPO-47 |

TABLE 3
Particle size determined from SEM

| | | Mean | | | | | | |
|---|---|---|---|---|---|---|---|---|
| | | particle | | | | | | |
| Sample | TMHD:IPA | size (nm) | SD | Min | Max | n | Morphology | Crystalline phase |
| S5 | 100%:0% | 96+E3 | 17+E3 | 78.5+E3 | 124+E3 | 9 | Round plate | SAPO-56 |
| S12 | 60%:40% | 157.1 | 19.5 | 117.3 | 188.4 | 12 | Bipyramids | SAPO-56 |
| | | | | | | | and | |
| | | | | | | | hexagonal | |
| | | | | | | | plates | |
| S15 | 50%:50% | 215.5 | 23.4 | 187.9 | 253.8 | 8 | Bipyramids | SAPO-56 |
| S20 | 40%:60% | 214.8 | 23.3 | 176 | 289 | 18 | Hexagonal | SAPO-56 |
| | | | | | | | plates | |
| S38 | 30%:70% | 331.7 | 48.4 | 264.1 | 445.8 | 37 | Hexagonal | SAPO-56 |
| | | | | | | | plates | |
| S55 | 20%:80% | 337.3 | 38.4 | 265.9 | 395.9 | 22 | Hexagonal | SAPO-47 |
| | | | | | | | plates | |
| S58 | 10%:90% | 381.4 | 44 | 303.3 | 473.5 | 29 | Hexagonal | SAPO-47 |
| | | | | | | | plates | |
| S81 | 0:100% | 427.3 | 136.3 | 276.5 | 703 | 16 | Rhomboidal | SAPO-47 |
| | | | | | | | shape | |

TABLE 4
Gel composition for SAPO-56 synthesis using IPA as co-SDA

| | | | | | | | | | | | Working | |
|---|---|---|---|---|---|---|---|---|---|---|---|---|
| | | | | | | | | | Temperature | Time | volume | Crystalline |
| Sample | TMHD:IPA | Al₂O₃ | P₂O₅ | SiO₂ | TMHD | IPA | H₂O | Seed | (° C.) | (h) | (v/v %) | phase |
| S10 | 60%:40% | 0.8 | 1.0 | 0.9 | 1.3 | 0.8 | 52.3 | NO | 210 | 95 | 50% | SAPO-56, |
| | | | | | | | | | | | | unidentified |
| | | | | | | | | | | | | phase |
| S11 | 60%:40% | 0.8 | 1.0 | 0.9 | 1.3 | 0.8 | 52.4 | NO | 210 | 95 | 14% | SAPO-56, |
| | | | | | | | | | | | | unidentified |
| | | | | | | | | | | | | phase |
| S12 | 60%:40% | 0.8 | 1.0 | 0.9 | 1.3 | 0.9 | 52.3 | YES | 210 | 95 | 14% | SAPO-56 |
| S13 | 50%:50% | 0.8 | 1.0 | 0.9 | 1.0 | 1.1 | 52.3 | NO | 210 | 95 | 14% | SAPO-56 |
| S14 | 50%:50% | 0.8 | 1.0 | 0.9 | 1.1 | 1.1 | 52.6 | YES | 210 | 95 | 14% | SAPO-56 |
| S15 | 50%:50% | 0.8 | 1.0 | 0.9 | 1.0 | 1.1 | 52.3 | NO | 210 | 95 | 14% | SAPO-56 |
| S16 | 60%:40% | 0.8 | 1.0 | 0.9 | 1.3 | 0.8 | 52.3 | YES | 210 | 95 | 50% | SAPO-56 |
| S17 | 50%:50% | 0.8 | 1.0 | 0.9 | 1.0 | 1.1 | 52.3 | YES | 210 | 95 | 50% | SAPO-56, |
| | | | | | | | | | | | | unidentified |
| | | | | | | | | | | | | phase |
| S18 | 40%:60% | 0.8 | 1.0 | 0.9 | 0.8 | 1.3 | 52.4 | YES | 210 | 96 | 50% | SAPO-56, |
| | | | | | | | | | | | | unidentified |
| | | | | | | | | | | | | phase |
| S19 | 40%:60% | 0.8 | 1.0 | 0.9 | 0.8 | 1.3 | 52.2 | YES | 210 | 72 | 14% | SAPO-56, |
| | | | | | | | | | | | | unidentified |
| | | | | | | | | | | | | phase |
| S20 | 40%:60% | 0.8 | 1.0 | 0.9 | 0.8 | 1.3 | 52.2 | YES | 210 | 96 | 14% | SAPO-56 |
| S21 | 40%:60% | 0.8 | 1.0 | 0.9 | 0.8 | 1.2 | 51.9 | NO | 210 | 96 | 14% | SAPO-56, |
| | | | | | | | | | | | | unidentified |
| | | | | | | | | | | | | phase |
| S22 | 50%:50% | 0.8 | 1.0 | 0.9 | 1.1 | 1.1 | 52.4 | YES | 210 | 72 | 50% | SAPO-56, |
| | | | | | | | | | | | | unidentified |
| | | | | | | | | | | | | phase |
| S23 | 50%:50% | 0.8 | 1.0 | 0.9 | 1.0 | 1.1 | 52.0 | YES | 210 | 96 | 14% | NO |
| | | | | | | | | | | | | PRODUCT |
| S24 | 30%:70% | 0.8 | 1.0 | 0.9 | 0.6 | 1.5 | 52.2 | YES | 210 | 96 | 49% | SAPO-56, |
| | | | | | | | | | | | | unidentified |
| | | | | | | | | | | | | phase |
| S25 | 30%:70% | 0.8 | 1.0 | 0.9 | 0.6 | 1.5 | 52.2 | YES | 210 | 96 | 14% | SAPO-56, |
| | | | | | | | | | | | | unidentified |
| | | | | | | | | | | | | phase |
| S27 | 40%:60% | 0.8 | 1.0 | 0.9 | 0.8 | 1.3 | 52.2 | YES | 210 | 96 | 14% | SAPO-56 |
| S28 | 40%:60% | 0.8 | 1.0 | 0.9 | 0.8 | 1.3 | 52.4 | YES | 210 | 114 | 14% | NO |
| | | | | | | | | | | | | PRODUCT |
| S29 | 30%:70% | 0.7 | 1.0 | 0.8 | 0.5 | 1.3 | 44.3 | YES | 210 | 114 | 14% | SAPO-56 |
| S30 | 30%:70% | 0.8 | 1.0 | 0.9 | 0.6 | 1.5 | 51.7 | YES | 210 | 114 | 14% | NO |
| | | | | | | | | | | | | PRODUCT |
| S31A | 30%:70% | 0.8 | 1.0 | 0.9 | 0.6 | 1.5 | 51.5 | YES | 210 | 114 | 12% | SAPO-56, |
| | | | | | | | | | | | | unidentified |
| | | | | | | | | | | | | phase |
| S31B | 30%:70% | | | | | | | | 210 | 114 | 12% | SAPO-56, |
| | | | | | | | | | | | | unidentified |
| | | | | | | | | | | | | phase |
| S31C | 30%:70% | | | | | | | | 210 | 114 | 12% | SAPO-56, |
| | | | | | | | | | | | | unidentified |
| | | | | | | | | | | | | phase |
| S32 | 30%:70% | 0.8 | 1.0 | 0.9 | 0.8 | 1.3 | 52.4 | YES | 210 | 114 | 47% | SAPO-56, |
| | | | | | | | | | | | | unidentified |
| | | | | | | | | | | | | phase |
| S37A | 30%:70% | 0.9 | 1.0 | 1.9 | 0.7 | 1.6 | 54.9 | YES | 210 | 98 | 12% | SAPO-56, |
| | | | | | | | | | | | | unidentified |
| | | | | | | | | | | | | phase |
| S37B | 30%:70% | | | | | | | | | 98 | 12% | SAPO-56, |
| | | | | | | | | | | | | unidentified |
| | | | | | | | | | | | | phase |
| S37C | 30%:70% | | | | | | | | | 98 | 12% | SAPO-56, |
| | | | | | | | | | | | | unidentified |
| | | | | | | | | | | | | phase |
| S38 | 30%:70% | 0.7 | 1.0 | 0.7 | 0.5 | 1.2 | 42.7 | YES | 210 | 48 | 14% | SAPO-56 |
| S39A | 30%:70% | 0.7 | 1.0 | 0.8 | 0.5 | 1.3 | 44.2 | YES | 210 | 48 | 12% | SAPO-56 |
| S39B | 30%:70% | | | | | | | | 210 | 77 | 12% | SAPO-56, |
| | | | | | | | | | | | | unidentified |
| | | | | | | | | | | | | phase |
| S39C | 30%:70% | | | | | | | | 210 | 99 | 12% | SAPO-56, |
| | | | | | | | | | | | | unidentified |
| | | | | | | | | | | | | phase |
| S40 | 30%:70% | 0.7 | 1.0 | 0.8 | 0.5 | 1.2 | 44.3 | YES | 100 | 48 | 30% | NO |
| | | | | | | | | | | | | PRODUCT |
| S41 | 30%:70% | 0.8 | 1.0 | 0.9 | 0.6 | 1.4 | 51.5 | YES | 210 | 77 | 14% | SAPO-56, |
| | | | | | | | | | | | | unidentified |
| | | | | | | | | | | | | phase |
| S42 | 30%:70% | 0.8 | 1.0 | 0.9 | 0.6 | 1.5 | 51.9 | YES | 210 | 99 | 14% | SAPO-56, |
| | | | | | | | | | | | | unidentified |
| | | | | | | | | | | | | phase |
| S43 | 30%:70% | 0.8 | 1.0 | 0.9 | 0.6 | 1.5 | 51.9 | YES | 210 | 148 | 14% | SAPO-56, |
| | | | | | | | | | | | | unidentified |
| | | | | | | | | | | | | phase |
| S45 | 30%:70% | 0.7 | 1.0 | 0.8 | 0.5 | 1.2 | 43.7 | YES | 180 | 47 | 40% | SAPO-47 |
| S47 | 30%:70% | 0.7 | 1.0 | 0.8 | 0.6 | 1.3 | 43.9 | YES | 190 | 47 | 40% | SAPO-47 |
| S48 | 30%:70% | 0.7 | 1.0 | 0.8 | 0.5 | 1.3 | 44.2 | YES | 200 | 48 | 20% | SAPO-56, |
| | | | | | | | | | | | | unidentified |
| | | | | | | | | | | | | phase |
| S49 | 30%:70% | 0.7 | 1.0 | 0.8 | 0.5 | 1.3 | 44.2 | YES | 200 | 48 | 30% | SAPO-56, |
| | | | | | | | | | | | | unidentified |
| | | | | | | | | | | | | phase |
| S50 | 30%:70% | 0.7 | 1.0 | 0.8 | 0.5 | 1.2 | 43.7 | YES | 200 | 48 | 40% | SAPO-56, |
| | | | | | | | | | | | | unidentified |
| | | | | | | | | | | | | phase |
| S51 | 30%:70% | 0.7 | 1.0 | 0.7 | 0.5 | 1.2 | 43.2 | YES | 200 | 48 | 12% | SAPO-56, |
| | | | | | | | | | | | | unidentified |
| | | | | | | | | | | | | phase |
| S52 | 30%:70% | | | | | | | YES | 200 | 48 | 30% | SAPO-56 |
| S53 | 30%:70% | 0.7 | 1.0 | 0.8 | 0.6 | 1.2 | 44.0 | YES | 195 | 51 | 40% | SAPO-56, |
| | | | | | | | | | | | | unidentified |
| | | | | | | | | | | | | phase |
| S54 | 30%:70% | 0.7 | 1.0 | 0.8 | 0.5 | 1.2 | 44.3 | YES | 195 | 51 | 40% | SAPO-56, |
| | | | | | | | | | | | | unidentified |
| | | | | | | | | | | | | phase |
| S55 | 20%:80% | 0.7 | 1.0 | 0.8 | 0.4 | 1.4 | 44.0 | YES | 195 | 51 | 40% | SAPO-47 |
| S56 | 20%:80% | 0.7 | 1.0 | 0.8 | 0.4 | 1.4 | 44.0 | YES | 195 | 51 | 40% | SAPO-47 |
| S57 | 10%:90% | 0.7 | 1.0 | 0.8 | 0.2 | 1.6 | 44.3 | YES | 195 | 51 | 40% | SAPO-47 |
| S58 | 10%:90% | 0.7 | 1.0 | 0.8 | 0.2 | 1.6 | 44.3 | YES | 195 | 51 | 40% | SAPO-47 |

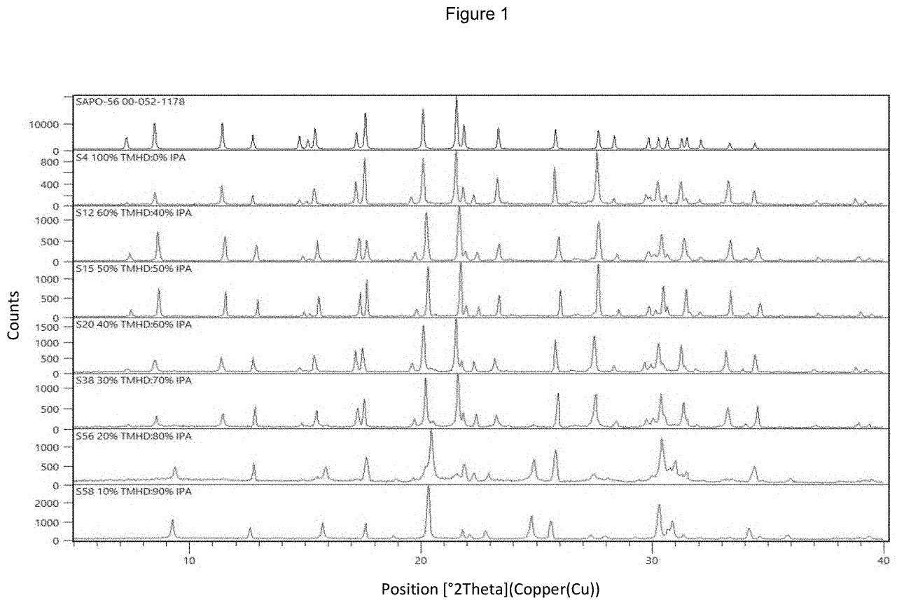

The success of using the IPA as a co-SDA was observed in the XRD pattern of the samples in the series. FIG. 1 shows the corresponding XRD patterns of the as synthesized products synthesized with co-SDA TMHD: IPA. The diffraction pattern of samples using 40 to 70% of IPA show peaks attributed to low-angle crystalline planes (100), (101), (102) and (110) of SAPO-56. Higher amount of IPA (i.e. 80 to 90%) lead to formation of other phase of SAPO. The lines 13.85° and 24.15° correspond to lines for the XRD of SAPO-17 (ERI) identified in some of the synthesis of SAPO-56 with only the TMHD template were not observed. The characteristic peaks at low angle 2θ values of 9.48 and 12.9 certainly correspond to the structurally related SAPO-47 (CHA), which has been synthesized using n-propylamine as single SDA recently (Xu et al. 2015, 123-128). SAPO-47 belongs to the CHA-like SAPO-solids, such as SAPO-44 and the much more common SAPO-34 (CHA). (T. Wang et al. 2010, 138-147).

[FIG. 1]

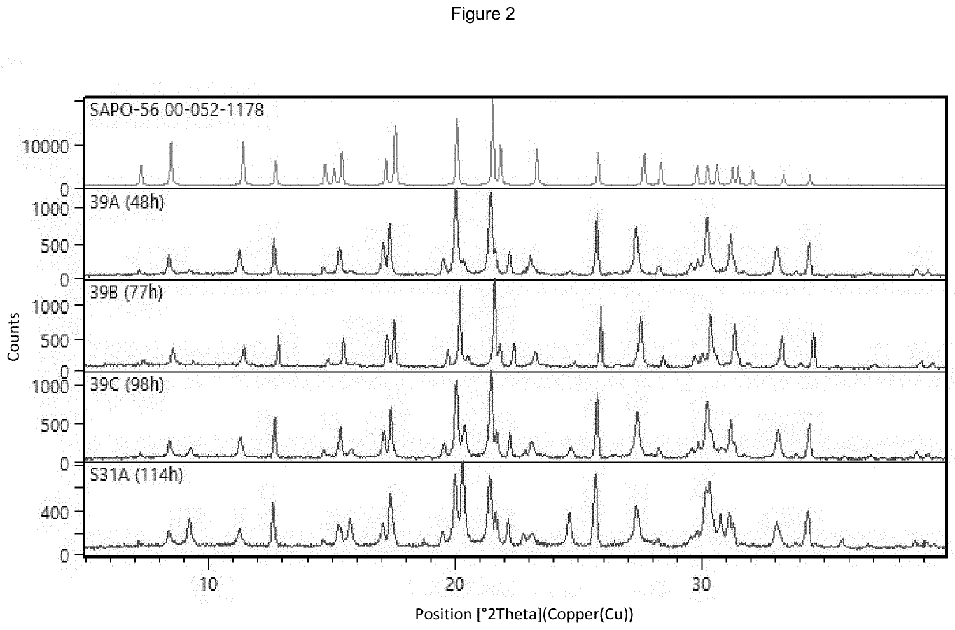

The purity of the SAPO-56 according to the present invention synthesized with a ratio of 70% IPA: 30% TMHD was evaluated. FIG. 2 displays XRD patterns formed at crystallization times of 48-114 h. From the differences it could be observed that SAPO-56 crystallized at short crystallization times (48 h) then the fraction of co-crystallized SAPO-47 increased with time. It appeared clear that 48 h was the preferred crystallization duration and 210 the preferred temperature. The mechanism for the co-crystallization of SAPO-47 is not fully clear, and it appears as further studies need to be performed to corroborate various hypotheses (for example SAPO-56 crystallites dissolution and recrystallization of SAPO-47). The occurrence of two crystalline phases during the synthesis of SAPO-56 using co-SDA has being reported, but not for the SAPO-47 (CHA). For example Cao and Shan et al. 2012 (Cao and Shah 2011) reported the intergrown of SAPO-56 (AFX) and SAPO-(CHA), using TMHD and N,N-dimethylcyclohexylamine as co-templates. While (Turrina et al. 2016, 4998-5012) reported SAPO-17 (ERI) and SAPO-34 (CHA) using 1,4-(1,4-diazabicyclo[2.2.2]octane)butyldibromide and trimethylamine. Recently (D. Wang et al. 2016, 1000-1008) reported the synthesis of SAPO-34 (CHA) and SAPO-56 using triethylamine and trimethylamine; however, they used HF as a mineralizer, which has it defined problems when it comes to upscaling.

[FIG. 2]

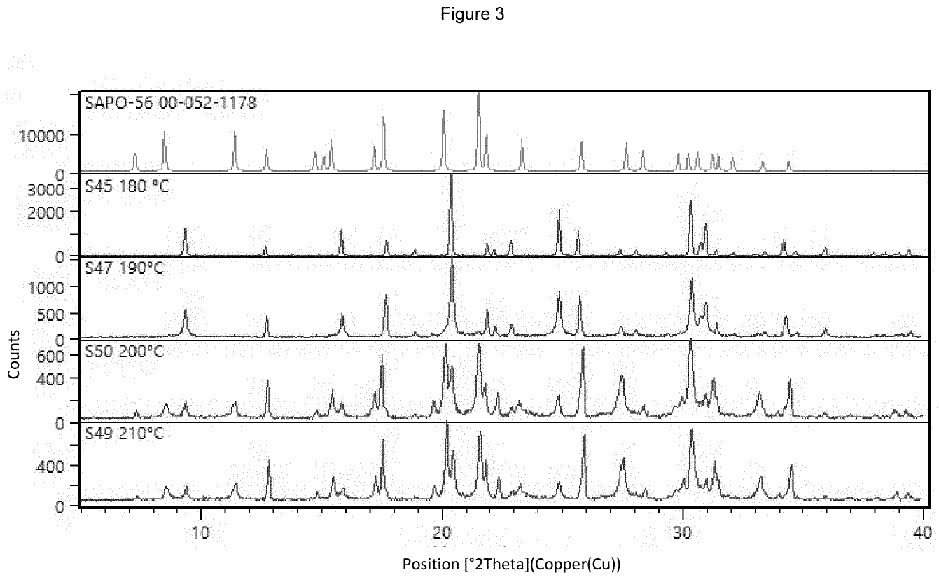

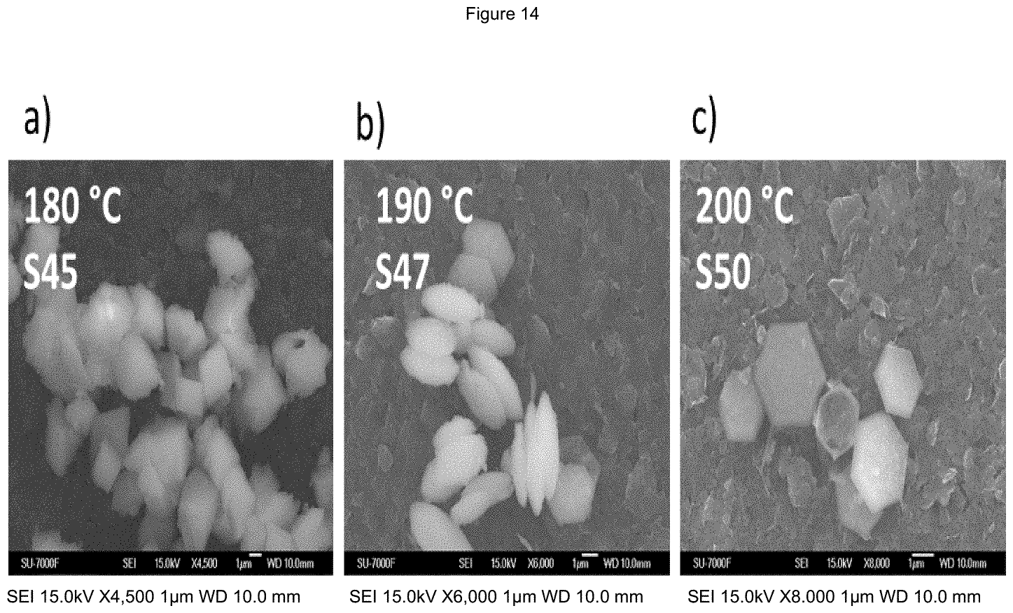

Also using a significant amount of IPA 70 molar % (44.5 weight %), FIG. 3 shows the effect of crystallization temperature on the SAPO phase obtained using similar gel conditions as in FIG. 2. The SAPO-47 was obtained at low temperatures 180 to 190° C., while the SAPO-56 started to co-crystallize at a temperature of 200° C. The addition of seeds did not influence the formation of SAPO-56 phase at a low temperature; however the crystals of SAPO-47 adopted the morphology (SEMs shown in FIG. 14) of SAPO-56 as was discussed above.

[FIG. 3]

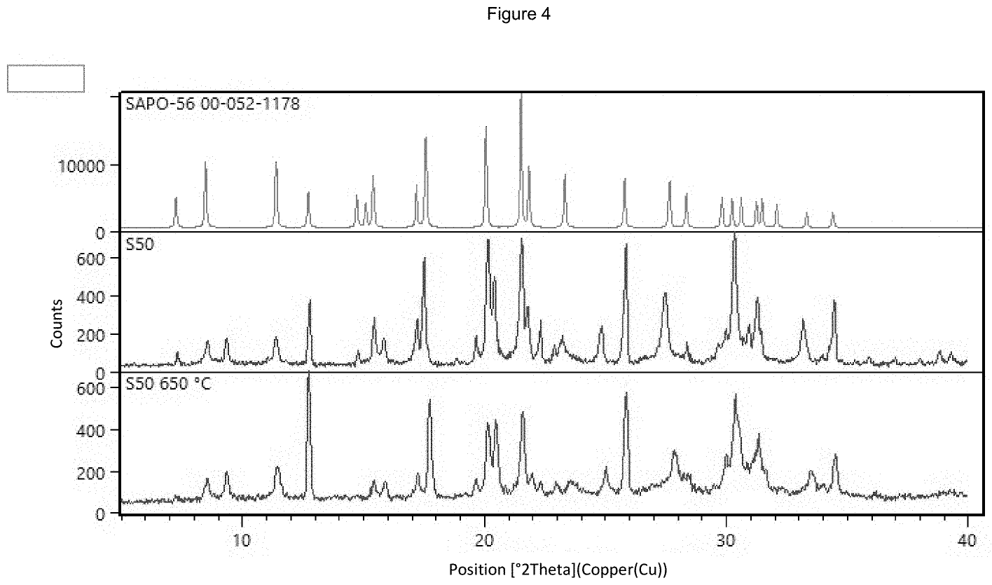

The stability of the crystalline structure of SAPO-56 after SDA removal was demonstrated by the XRD diffactograms presented in FIG. 4. Note, that a complete SDA removal and its sub-products appears to occur at as a high temperature as 720° C., as was corroborated by TGA (data not shown).

[FIG. 4]

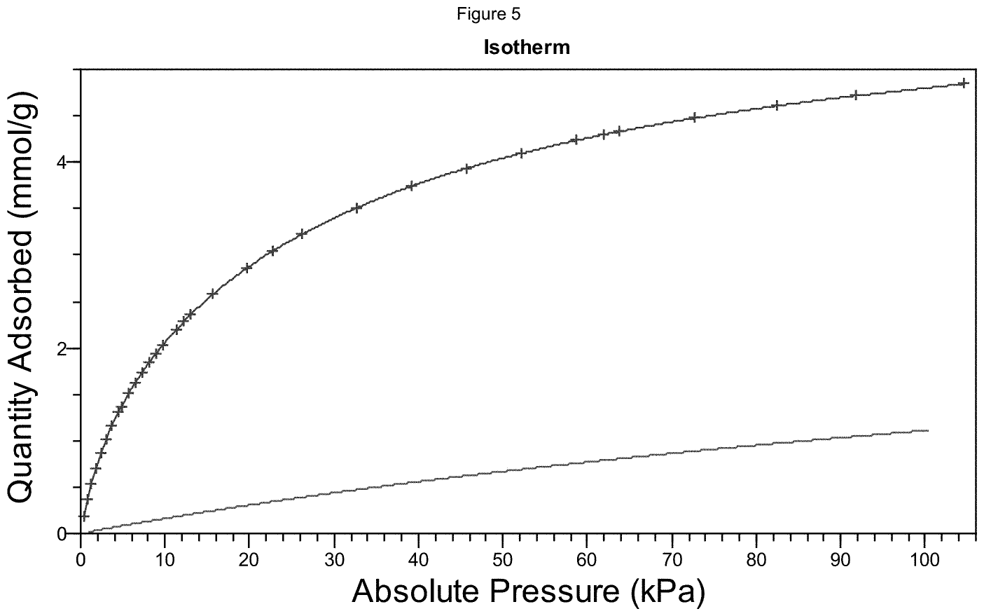

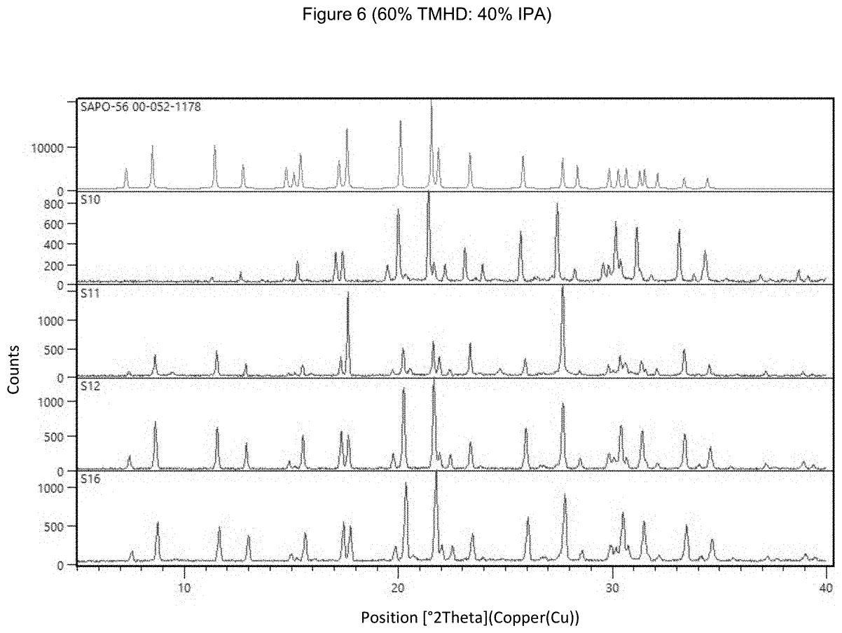

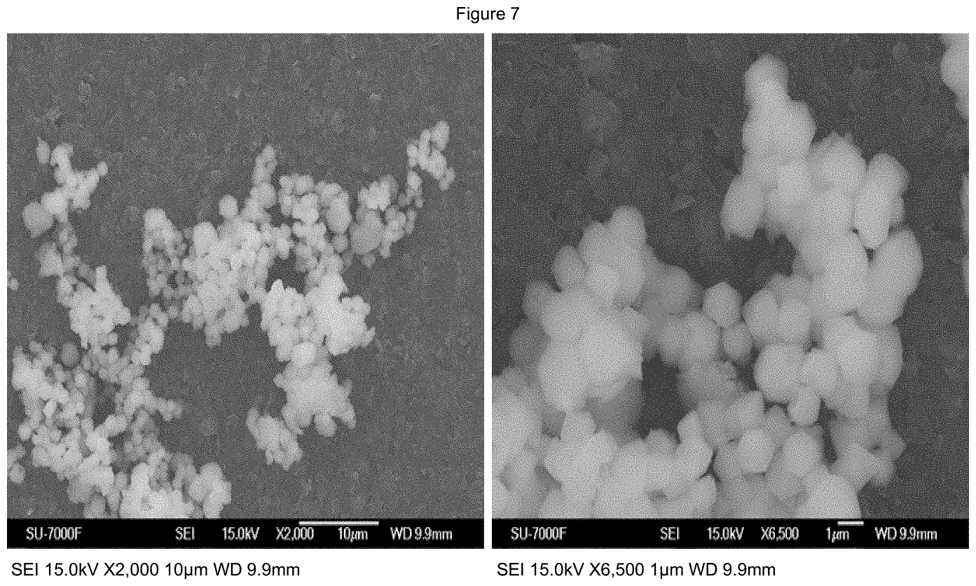

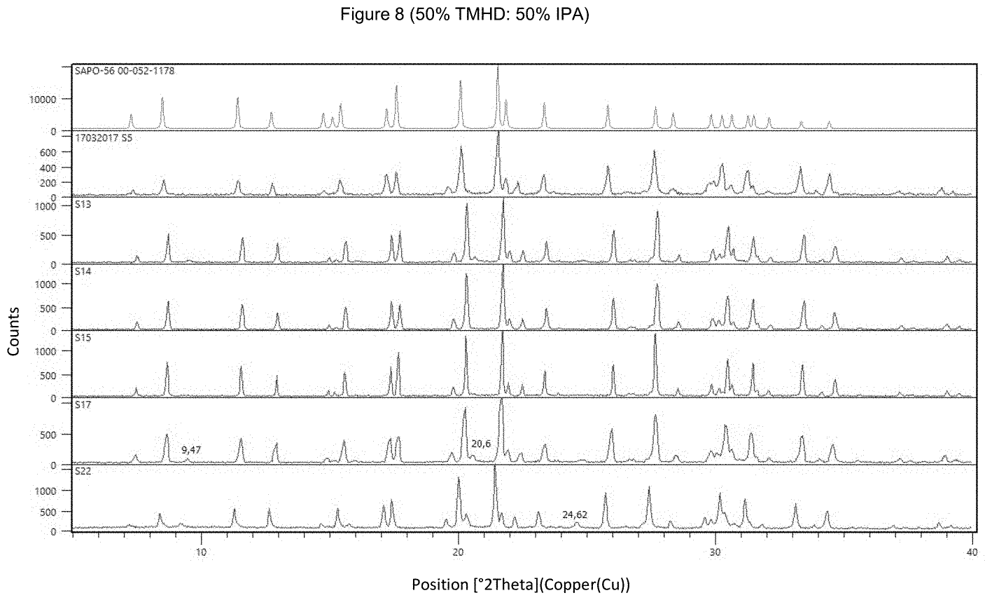

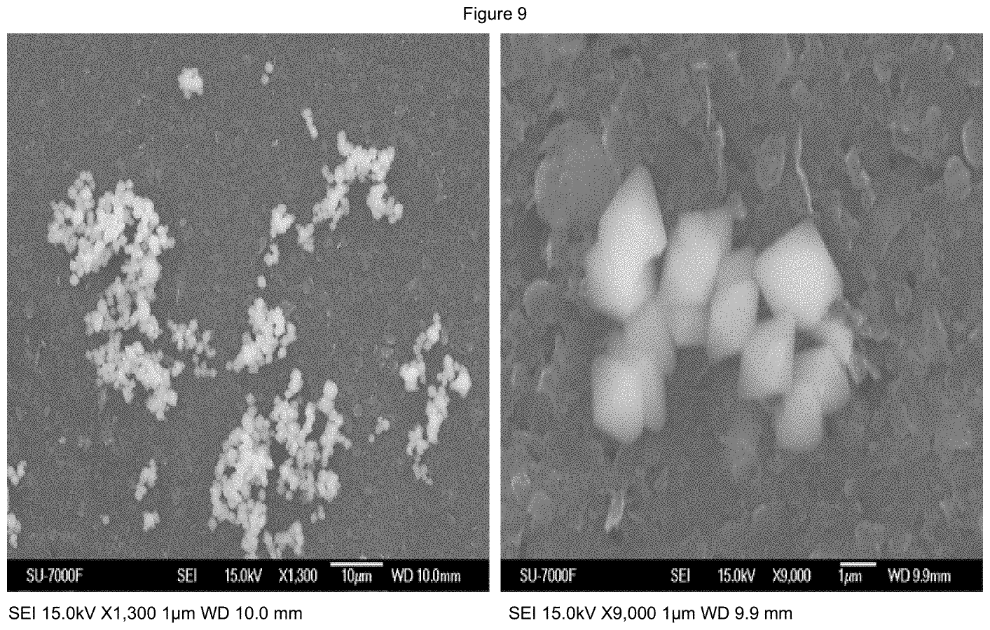

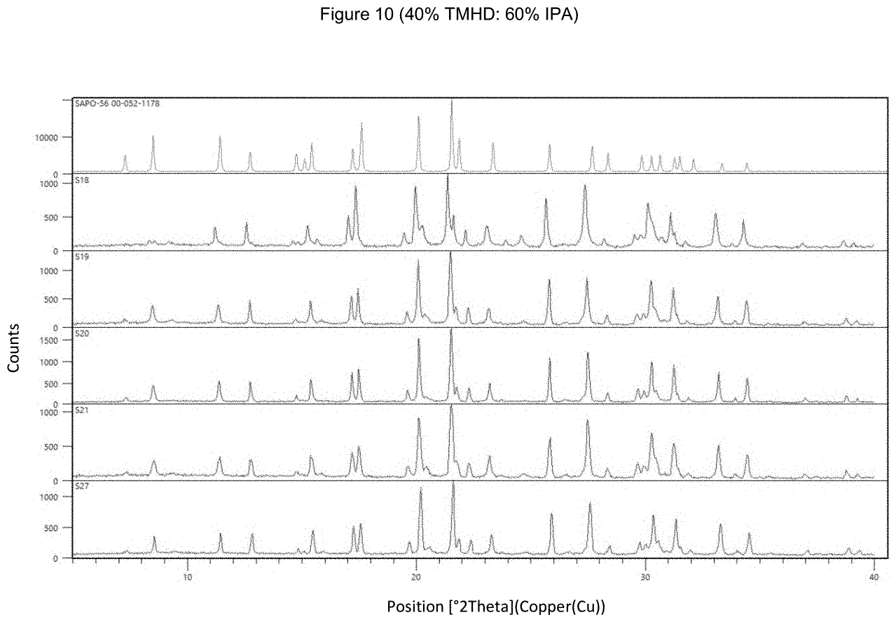

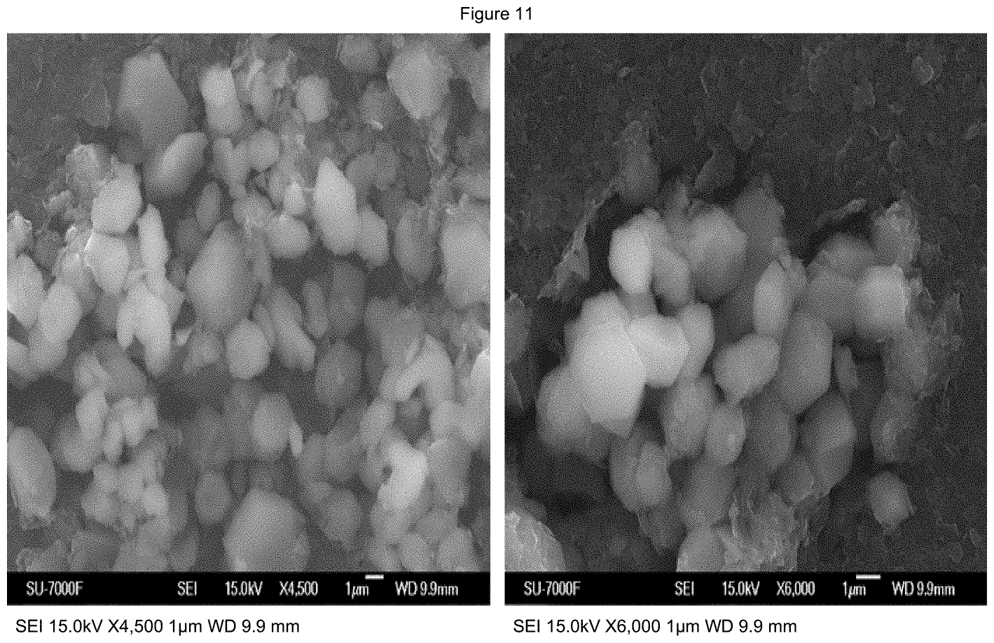

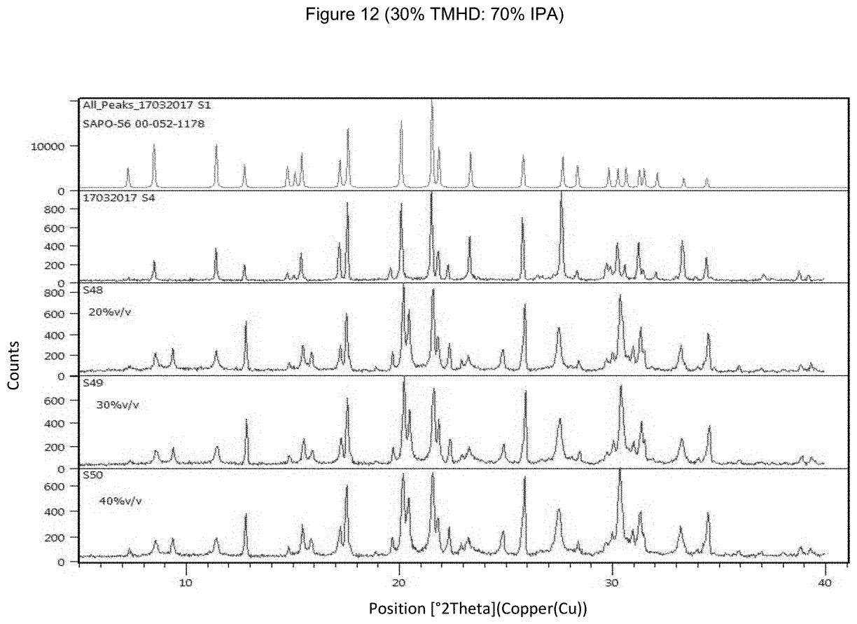

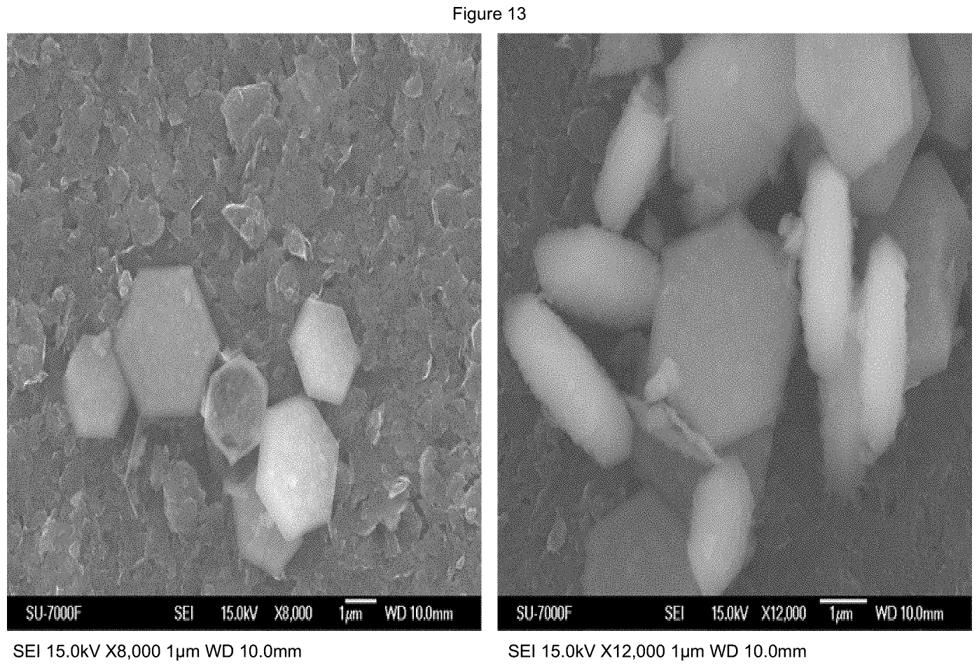

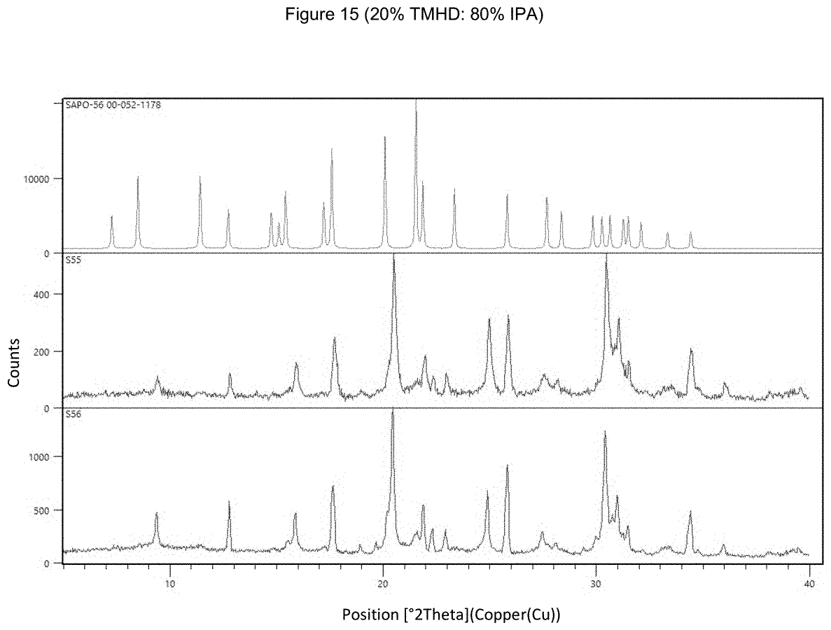

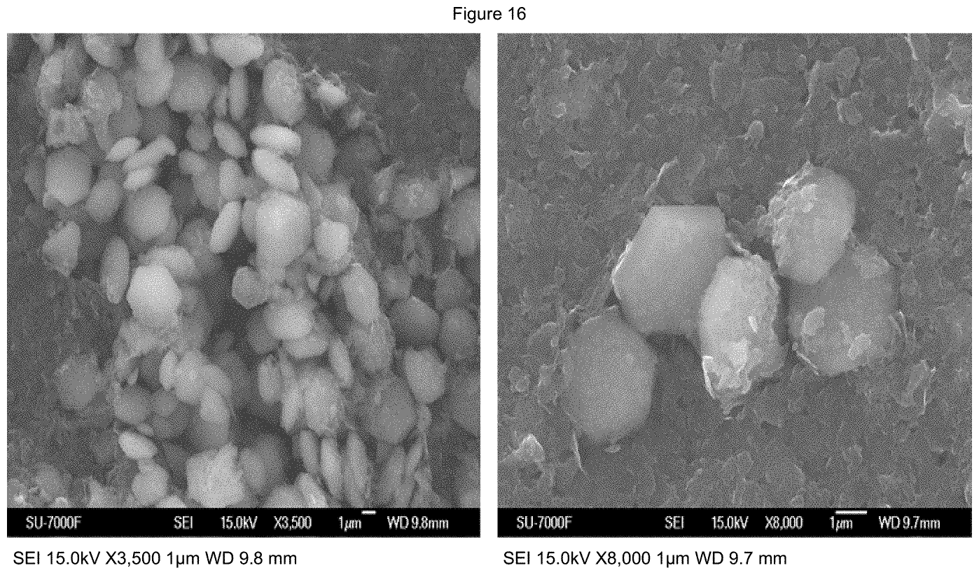

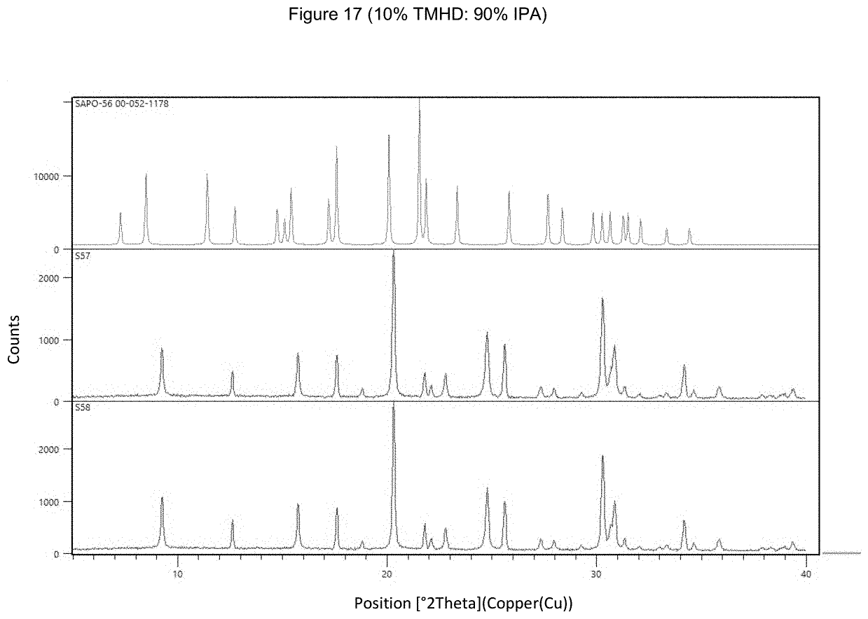

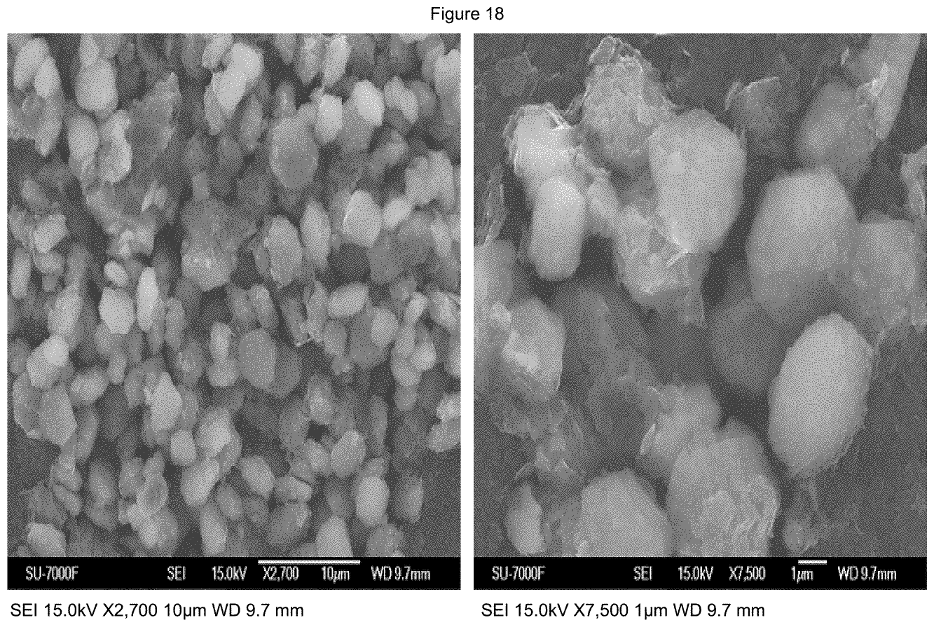

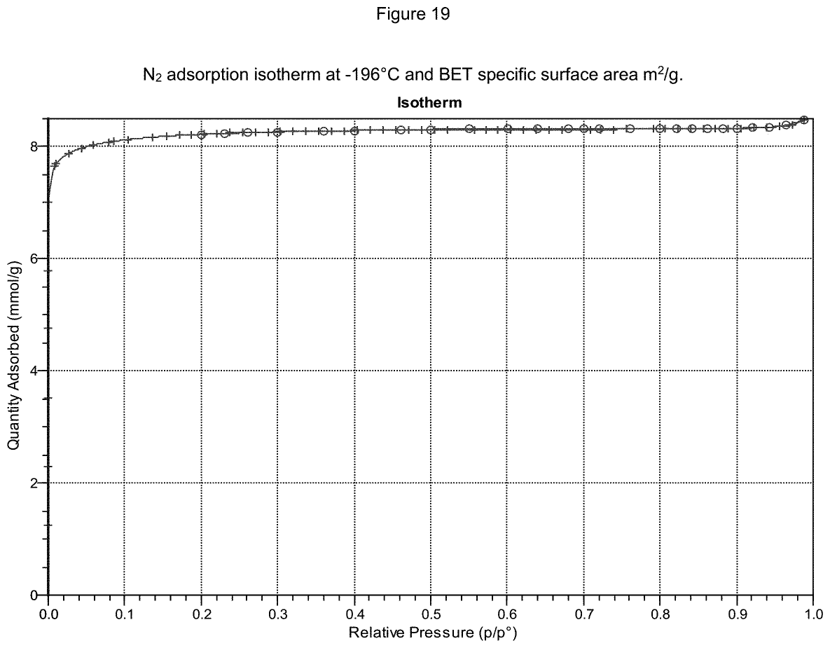

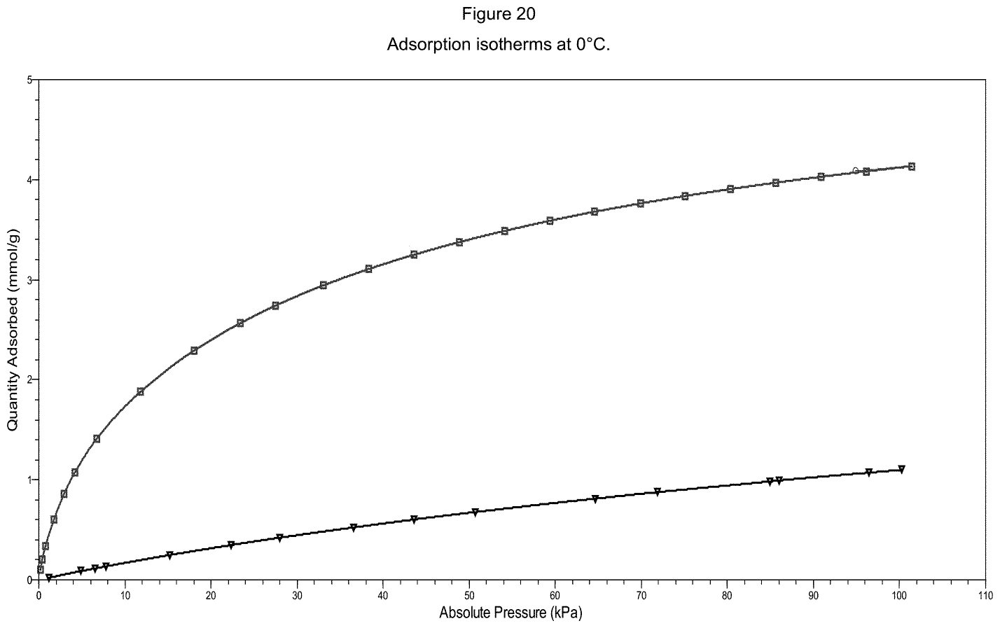

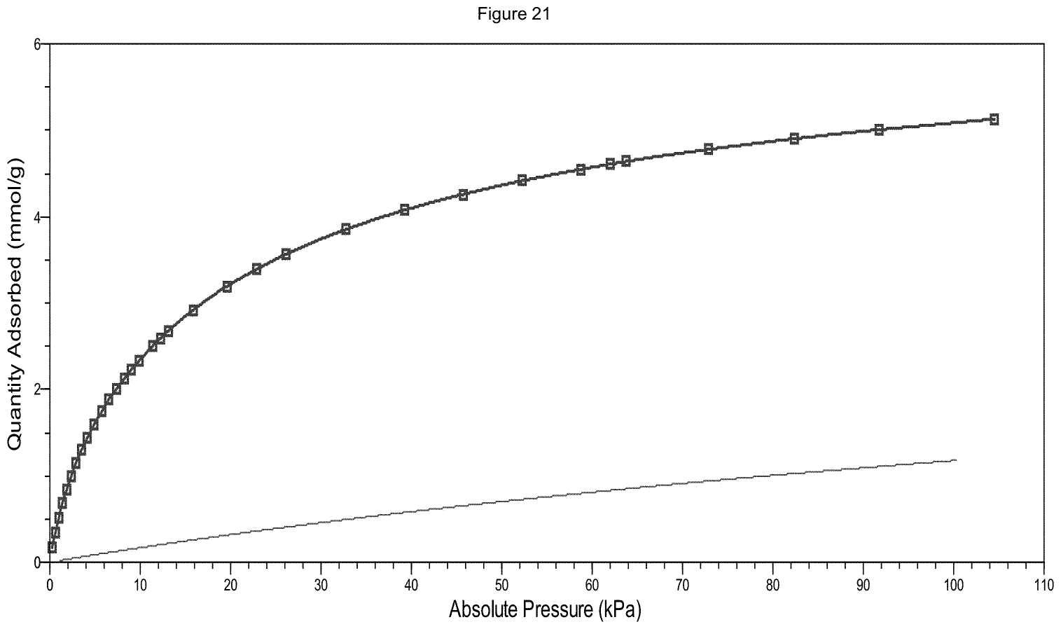

Gas adsorption performance tests were performed. The CO₂ and CH₄ adsorption isotherms were recorded at temperature of 0° C. FIG. 10 show a high CO₂ adsorption capacity of 4.15 mmol/g and CH₄ adsorption capacity of 1.12 mmol/g at 101 kPa. The estimated selectivity is 6.0 using the simple model (V1/V2)/(p1/p2) for a 50%/50% CO₂/CH₄ gas mixture that simulate the biogas composition used for upgrading. This selectivity value is comparable to the reported by (Bacsik et al. 2016a, 613-621) for SAPO-56 and tested also here (FIG. 20) surpasses those of ALPO-17, activated carbon and metal organic framework.

[FIG. 5]

[FIG. 6]

[FIG. 7]

[FIG. 8]

[FIG. 9]

[FIG. 10]

[FIG. 11]

[FIG. 12]

[FIG. 13]

[FIG. 14]

[FIG. 15]

[FIG. 16]

[FIG. 17]

[FIG. 18]

[FIG. 19]

[FIG. 20]

[FIG. 21]

Further Experimental Data:

Additional Synthesis of Seeds of SAPO-56

Regular SAPO-56 was crystallized from gels with a starting molar composition of 2.1 TMHD: 0.9 SiO₂: 0.8 Al₂O₃: 1 P₂O₅: 50 H₂O. In a typical procedure, 9 g of distilled water, 2.2 g of phosphoric acid (85 wt. % in water, Sigma Aldrich) and 1.1 g of pseudoboehmite (Aluminum Corporation of China, Shandong) were added to a polypropylene vessel, which was closed and vigorously stirred for 2 h at room temperature. After this, 1 mL of a LUDOX® HS-40 colloidal silica (40 wt. % suspension in water containing stabilizing Na⁺ at pH equal to 9.8, Sigma Aldrich) was added, and the mixture was stirred for 1 h. Finally, 3.45 g of TMHD (99% Sigma Aldrich) was added under vigorous mixing for 24 h. On the addition of TMHD, the temperature increased temporarily, and the mixture thickened. The gel was transferred to 100 mL-sized and Teflon™-lined stainless-steel autoclaves and was heated at 190-210° C. for 2-4 days. The solid and liquid phases were recovered and separated by decantation. The yellow and gelatinous phase top phase was discarded, while the white solid phase was thoroughly washed with an excess of distilled water (resuspension and centrifugation cycles of 6000 rpm for 5 min) and dried in a conventional oven at a temperature of 80° C. overnight. Sample “calcination” was performed at 650° C. for 12 h to remove the SDA.

In addition to the LUDOX® HS-40 colloidal silica, we synthesized SAPO-56 using fumed silica (0.2-0.3 μm aggregates, pH of 3.6 to 4.3 at 40 g/L, Sigma Aldrich) in similar manner. It was added in similar molar ratios and method described.

Synthesis of SAPO-56 Using Additional Co-SDAs

SAPO-56 was crystallized with the SDA and co-SDAs by using a starting gel with molar compositions of 2.1 (SDA+co-SDA): x SiO₂: y Al₂O₃: z P₂O₅: 50 H₂O with a similar preparation procedure as was described under the additional synthesis of seeds of SAPO-56. The (Al+P)/Si_{gel} ratio is defined as 2y+2z/x. The co-SDA were primary (IPA, purity >99.5% Sigma Aldrich), secondary (DBA, purity >99.5% Sigma Aldrich) and tertiary amines (TPA, purity >98% Sigma Aldrich). Synthetic details are presented in the Tables 5. Seeds of as-synthesized SAPO-56 (prepared with TMHD) was added to the gels immediately after the SDA and co-SDA under vigorous stirring. The gels were aged for 24 h, transferred to Teflon-lined stainless-steel autoclaves, and heated at 200-210° C. for 2-4 days. The white solid products were recovered and thoroughly washed with an excess of distilled water (resuspension and centrifugation cycles of 6000 rpm for 5 min) and dried in a conventional oven at a temperature of 80° C. overnight. Sample “calcination” was performed at 650° C. for 12 h to remove the SDA and co-SDA.

Characterization of the Silicoaluminophosphate SAPO-56 of the Further Experimental Data

X-ray diffraction patterns of the as-synthesized products were recorded on an X'Pert alpha 1 P analytical diffractometer using Cu-Kα radiation and a PIXCEL detector, in the 2θ range of 5-40°.

Scanning electron microscopy (SEM) images were captured with a JEOL JSM-7000F microscope using a working distance of 10 mm, and voltage of 5 to 15 kV. As-synthesized and powders were spread on carbon-coated aluminum holders before SEM experiments were conducted. Elemental analysis was performed over a number of particles by using an INCA Energy Dispersive X-ray Spectroscopy detector (EDS) at 15 kV, and quantification was performed with the INCA Microanalysis Suite v4.15. Average particle sizes were estimated from the SEM images with the ImageJ software. At least 20 particles from three different areas of each sample were counted.

Thermogravimetric analysis (TG) and derivative thermogravimetric analysis (DTG) was performed in technical air with a Discovery TGA-TA Instruments analyzer using an airflow of 20 mL/min and heating rate of 10° C/min.

Solid-state {¹H}¹³C Nuclear Magnetic Resonance (NMR) spectra were recorded in a 4-mm probe head under Magic Angle Spinning (MAS) of 14 kHz on a 600 MHz Bruker Avance III spectrometer (with a wide-bore magnet). A ramped crosspolarization with a contact time of 1.6 ms was used for the transfer of the ¹H—¹³C magnetization, and SPINAL decupling of the¹H magnetization was used during the detection of the ¹³C transients. For each spectrum, 5120 transients were acquired. A small amount of exponential apodization was applied to the free induction decay before Fourier transformation, and the ¹³C chemical shift scale was externally calibrated to the methine shift of 38.6 ppm of adamantane.

N₂, CO₂ and CH₄ Adsorption for Samples from the Further Experimental Data

Gas adsorption tests were performed on a Micromeritics ASAP2020 surface area and porosity analyzer, and the “calcined” sample was subjected to dynamic vacuum at a temperature of 350° C. (heating rate 10° C/min) for 6 h. The sample was backfilled to 101 kPa with N₂ before recording of the N₂, CO₂ and CH₄ isotherms.

CO₂ and CH₄ adsorption data were recorded at 0° C. up to an absolute pressure of 101 kPa. The temperature was set by an ice bath. The data points were recorded when the pressure change was less than 0.01% during a 10 s interval. While, N₂ adsorption data were recorded at −196° C. and the temperature was set by a liquid nitrogen bath. The data were analyzed using MicroActive™ Interactive Data Analysis software.

The Brunauer-Emmett-Teller (BET) surface area was calculated at relative pressure 0.0001-0.05 and based on the criterion of linearity of the plot Q(1−P/P₀) vs P/P₀. ³³ The micropore volume was calculated from the N₂ isotherm using t-plot method, and the ultramicropore volume from CO₂ isotherm was estimated by using a CO2-DFT model derived for slit-like carbon-based materials.

TABLE 5
Gel composition (molar basis) 1.7-2.1 TMHD, co-SDA: x SiO₂: y
Al₂O₃: z P₂O₅: 40-55 H₂O, experimental conditions for the synthesis
of SAPO-56 and complementary data from the literature.

| | | | | | | | | Temperature | Time | Crystalline |
|---|---|---|---|---|---|---|---|---|---|---|
| Sample | TMHD | x | y | z | H₂O | (Al + P)/Si_{gel} | Seed | (° C.) | (h) | phase |
| This work | 2.10 | 0.91 | 0.82 | 1 | 52 | 4 | NO | 210 | 95 | SAPO-56 |
| S-4 | | | | | | | | | | |
| This work | 2.10 | 1.9 | 0.86 | 1 | 55 | 1.95 | NO | 210 | 95 | SAPO-56 |
| S-5 | | | | | | | | | | |
| This work | 2.10 | 0.64 | 0.82 | 1 | 53 | 5.7 | NO | 210 | 95 | SAPO-56 |
| S-9 | | | | | | | | | | |
| This work | 1.76 | 0.76 | 0.69 | 1 | 44 | 4.45 | YES | 190 | 47 | SAPO-56 |
| S-46 | | | | | | | | | | |
| This work | 1.77 | 0.77 | 0.70 | 1 | 44 | 4.43 | YES | 200 | 48 | SAPO-56 |
| S-72 | | | | | | | | | | |
| 25 | 1 | 0.60 | 1.00 | 1 | 40 | 6.66 | — | 200 | 96 | SAPO-56 |
| 20 | 2 | 0.60 | 0.80 | 1 | 40 | 6.00 | — | 200 | 96 | SAPO-56 |
| 17 | 2 | 0.60 | 0.80 | 0.5 | 50 | 4.30 | — | 200 | 60 | SAPO-56 |
| 36 | 2 | 0.60 | 0.80 | 1 | 50 | 6.00 | — | 200 | 48 | SAPO-56 |
| Sample B | | | | | | | | | | |
| 36 | 2 | 0.92 | 0.72 | 0.72 | 50 | 3.13 | — | 200 | 48 | SAPO-56 |
| Sample C | | | | | | | | | | |
| 37 | 2 | 0.60 | 0.80 | 1 | 200 | 6.00 | — | 210 | 48 | SAPO-56 |
| Sample c | | | | | | | | | | |
| 37 | 2 | 0.60 | 0.80 | 1.4 | 200 | 7.33 | — | 200 | 24 | SAPO-56 |
| Sample i | | | | | | | | | | |

TMHD means N,N,N′,N′-tetramethyl-1,6-hexanediamine

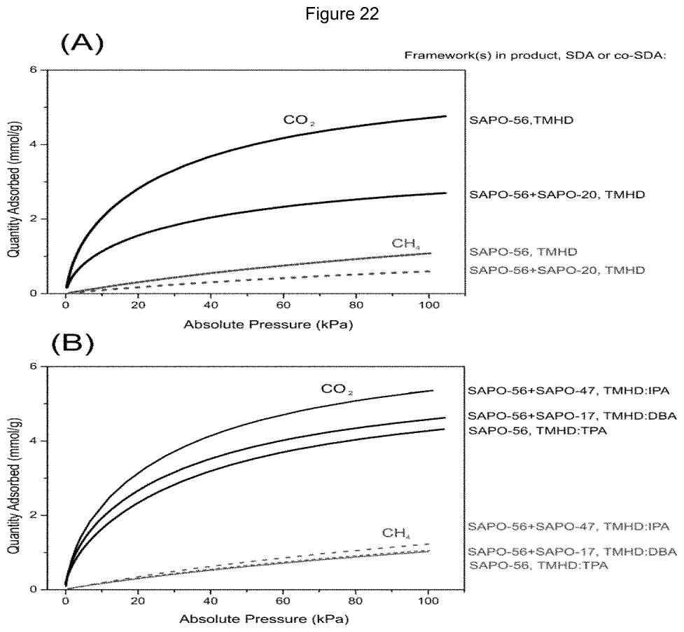

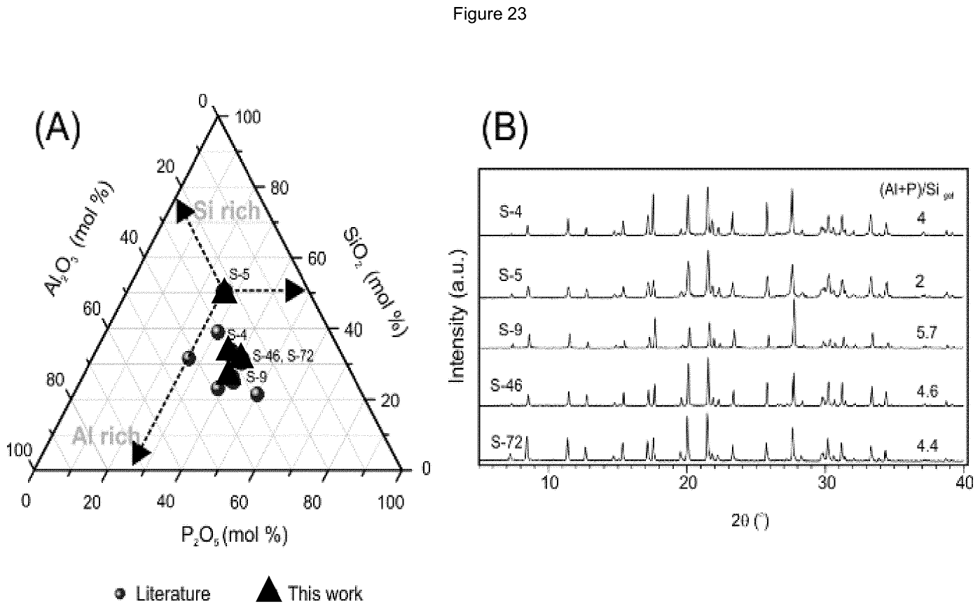

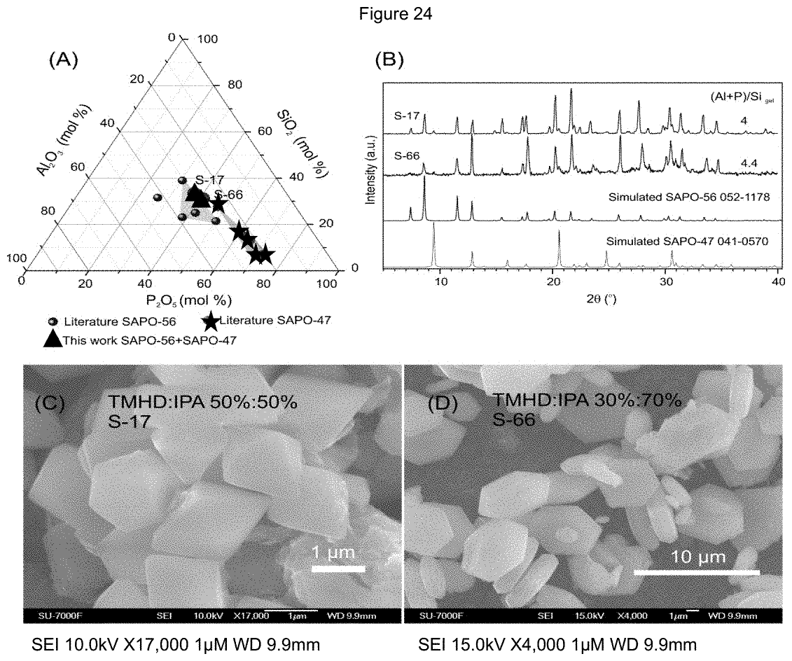

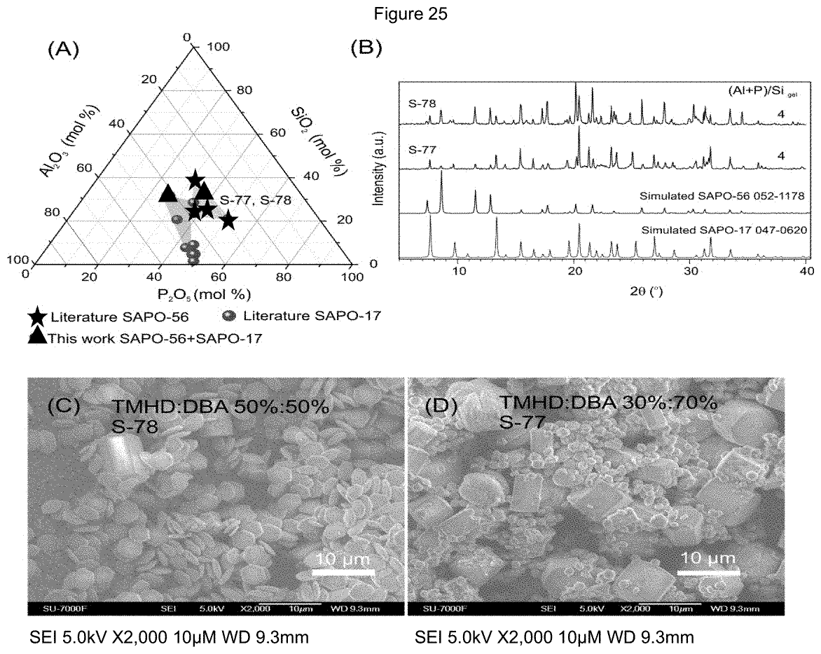

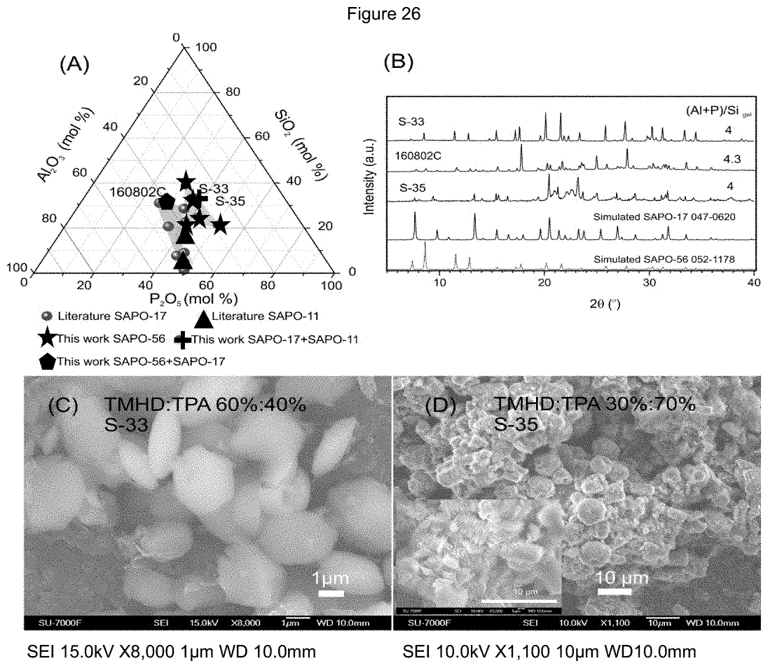

TABLE 6
Surface area and (ultra)micropore volume of SAPO-56 synthesized with TMHD and TMHD: co-SDAs.

| | | | BET | | | | |
|---|---|---|---|---|---|---|---|
| | | | specific | | | | |
| | | | surface | Pore volume (cm³/g) | | Uptake of | Uptake of |
| | | Phase | areas | Ultramicropore | Micropore by | CO₂ | CH₄ |
| Sample | SDA:co-SDA | (s) | (m²/g) | by DFT method^{b} | t-plot ^{d} | (mmol/g) | (mmol/g) |
| S-4 | 100% TMHD | SAPO-56 | 2.97 | 97E−5 | — | 0.11 | 0.05 |
| S-72 | 100% TMHD | SAPO-56 | 451 | 0.15 | 0.17 | 4.73 | 1.08 |
| S-26 | 100% TMHD | SAPO-56 + | — | 0.08 | — | 2.69 | 0.59 |
| | | SAPO-20 | | | | | |
| S-17 | 50% TMHD:50% IPA | SAPO-56 + | 644 | 0.17 | 0.25 | 5.35 | 1.23 |
| | | SAPO-47 | | | | | |
| S-78 | 50% TMHD:50% DBA | SAPO-56 + | 731 | 0.14 | 0.28 | 4.61 | 1.04 |
| | | SAPO-17 | | | | | |
| S-33 | 60% TMHD:40% TPA | SAPO-56 | 715 | 0.12 | 0.27 | 4.29 | 1.02 |

[FIG. 22]

[FIG. 23]

[FIG. 24]

[FIG. 25]

[FIG. 26]

### LIST OF REFERENCES

Liu, Xinyuan, Ruying Li, Min Ji, and Li Han. 2013. “Hydrogen and Methane Production by Co-Digestion of Waste Activated Sludge and Food Waste in the Two-Stage Fermentation Process: Substrate Conversion and Energy Yield.” Bioresource Technology 146: 317-323.

Hermann, BG, L. Debeer, B. De Wilde, K. Blok, and Martin Kumar Patel. 2011. “To Compost Or Not to Compost: Carbon and Energy Footprints of Biodegradable Materials' Waste Treatment.” Polymer Degradation and Stability 96 (6): 1159-1171.

Zhou, Kui, Somboon Chaemchuen, and Francis Verpoort. 2017. “Alternative Materials in Technologies for Biogas Upgrading Via CO 2 Capture.” Renewable and Sustainable Energy Reviews 79: 1414-1441.

Brent, M. T. L., A. M. Celeste, R. L. Patton, R. T. Gaiek, T. R. Cannan, and E. M. Lanigen. 1984. Crystalline Silicoaluminophosphates, edited by UNION CARBIDE CORPORATION. Vol. 83107267.3 BO1J20/18.

Cao, Guang and Matu J. Shah. 2011. Intergrown Molecular Sieve, its Synthesis and its use in the Conversion of Oxygenates to Olefins, edited by GUANG CAO, MATU J. SHAH and EXXONMOBIL CHEMICAL PATENTS INC US 8,163,259 B2.

Wang, Dehua, Miao Yang, Wenna Zhang, Dong Fan, Peng Tian, and Zhongmin Liu. 2016. “Hollow Nanocrystals of Silicoaluminophosphate Molecular Sieves Synthesized by an Aminothermal Co-Templating Strategy.” CrystEngComm 18 (6): 1000-1008.

Turrina, Alessandro, Raquel Garcia, Paul A. Cox, John L. Casci, and Paul A. Wright. 2016. “Retrosynthetic Co-Templating Method for the Preparation of Silicoaluminophosphate Molecular Sieves.” Chemistry of Materials 28 (14): 4998-5012.

Bacsik, Zoltan, Ocean Cheung, Petr Vasiliev, and Niklas Hedin. 2016. “Selective Separation of CO 2 and CH 4 for Biogas Upgrading on Zeolite NaKA and SAPO-56.” Applied Energy 162: 613-621.

Treacy, Michael MJ and John B. Higgins. 2007. Collection of Simulated XRD Powder Patterns for Zeolites Fifth (5th) Revised Edition Elsevier.

Xu, XT, JP Zhai, YP Chen, IL Li, SC Ruan, and ZK Tang. 2015. “Synthesis of Large Optically Clear SAPO-47 Single Crystals using N-Propylamine as Template.” Journal of Crystal Growth 426: 123-128.

Wang, Tizhuang, Xuchen Lu, and Yan Yan. 2010. “Synthesis, Characterization and Crystallization Mechanism of SAPOs from Natural Kaolinite.” Microporous and Mesoporous Materials 136 (1-3): 138-147.

1. A method for preparing a silicoaluminophosphate sorbent comprising:
providing a reaction mixture, said mixture comprising: a silicon-containing composition, an aluminum-containing composition, a phosphorous-containing composition, and a structure directing agent (SDA);
crystallization of the reaction mixture thereby providing crystallized silicoalum inophosphate;
recovering crystalline silicoaluminophosphate from the mixture;
wherein the structure providing agent (SDA) comprises N,N,N′,N′-tetramethyl-1,6-hexanediamine (TMHD) and a co-structure providing agent (co-SDA) selected among primary, secondary and tertiary amines comprising up to 15 carbon atoms and mixtures thereof.

2. The method according to claim 1, wherein the co-SDA is selected among primary amines comprising a saturated hydrocarbon comprising up to 6 carbon atoms.

3. The method according to claim 1, wherein the silicoaluminophosphate sorbent is selected among SAPO-47 and SAPO-56.

4. The method according to claim 1, wherein the silicoaluminophosphate sorbent is SAPO-56.

5. The method according to claim 1, wherein the SDA comprises up to about 75% wt of the co-SDA.

6. The method according to claim 1, wherein the primary, secondary and tertiary amines comprise saturated hydrocarbons.

7. The method according to claim 6, wherein the saturated hydrocarbons comprise from 2 up to 4 carbon atoms.

8. The method according to claim 1, wherein the co-SDA is selected among isopropylamine (IPA), dibutylamine (DBA), tripropylamine (TPA) and mixtures thereof.

9. A method for preparing a SAPO-56 sorbent comprising:
providing a reaction mixture, said mixture comprising a silicon-containing composition; an aluminum-containing composition; a phosphorous-containing composition; and a structure directing agent (SDA),
crystallization of the reaction mixture thereby providing crystallized silicoalum inophosphate;
recovering crystalline silicoaluminophosphate from the mixture,
wherein the structure providing agent (SDA) comprises at least a primary amine comprising a saturated hydrocarbon comprising up to 6 carbon atoms.

10. The method according to claim 9, wherein the primary amine comprises up to 3 carbon atoms.

11. The method according to claim 9, wherein the primary amine is isopropylamine (IPA).

12. The method according to claim 9, wherein the SDA further comprises N,N,N′,N′-tetramethyl-1,6-hexanediamine (TMHD).

13. A silicoaluminophosphate sorbent obtained by the method according to claim 1.

14. A silicoaluminophosphate sorbent comprising a structure providing agent (SDA) comprising N,N,N′,N′-tetramethyl-1,6-hexanediamine (TMHD) and a co-structure providing agent (co-SDA) selected among primary, secondary and tertiary amines comprising up to 15 carbon atoms and mixtures thereof.

15. The silicoaluminophosphate sorbent according to claim 14, wherein the silicoaluminophosphate sorbent comprises SAPO-56 and optionally SAPO-47 and the co-SDA is isopropylamine (IPA).

16. The silicoaluminophosphate sorbent according to claim 14, wherein the silicoaluminophosphate sorbent comprises SAPO-56 and co-structure providing agents (co-SDAs), where the amount of co-SDAs is at least about 10 mol % and the BET specific surface area (m²/g) is above about 500.

17. The silicoaluminophosphate sorbent according to claim 14, wherein the silicoaluminophosphate sorbent comprises SAPO-56 comprising particles, said particles having a mean particle size of less than about 1000 nm.

18. The silicoaluminophosphate sorbent according to claim 14, wherein the silicoaluminophosphate sorbent comprises SAPO-56 comprising particles being bipyramidal and/or hexagonal plates.

19. A process for the separation of CO2 from methane, the process comprising the use of a sorbent as defined by claim 13.
